(19) United States
(12) Patent Application Publication
(10) Pub. No.: US 2020/0045090 A1
(43) Pub. Date: Feb. 6, 2020

(54) INFORMATION PROCESSING SYSTEM, INFORMATION PROCESSING APPARATUS, AND INFORMATION PROCESSING METHOD

(71) Applicant: HIROSHI BABA, Kanagawa (JP)

(72) Inventor: HIROSHI BABA, Kanagawa (JP)

(73) Assignee: Ricoh Company, Ltd., Tokyo (JP)

(21) Appl. No.: 16/445,800

(22) Filed: Jun. 19, 2019

(30) Foreign Application Priority Data
Jul. 31, 2018 (JP) 2018-144472

(51) Int. Cl. H04L 29/06

(52) U.S. Cl. CPC H04L 65/1089; H04L 65/403; H04L 65/4023

(57) ABSTRACT

An information processing system, an information processing apparatus, and an information processing method. The information processing system including an information processing apparatus and a plurality of terminals connected to the information processing apparatus determines, in response to a request sent from one of the terminals to a first address to start an electronic meeting, which one of personal content for each terminal and shared content shared between the terminals to display on the terminal that accessed the first address; and redirects the terminal that accessed the first address to one of a second address of the personal content and a third address of the shared content, according to a determination result.

### CROSS-REFERENCE TO RELATED APPLICATIONS

This patent application is based on and claims priority pursuant to 35 U.S.C. § 119(a) to Japanese Patent Application No. 2018-144472, filed on Jul. 31, 2018, in the Japan Patent Office, the entire disclosure of which is hereby incorporated by reference herein.

### BACKGROUND

### Technical Field

The present disclosure relates to an information processing system, an information processing apparatus, and an information processing method.

### Background Art

Electronic meeting systems allow a plurality of terminals to perform an electronic meeting through a communication network. Some electronic meeting systems can store information to be shared and used by participants and information to be used individually by each participant on a server.

In addition, a technique that allows information being displayed by a specific terminal to be shared and displayed by a plurality of other terminals is available.

### SUMMARY

Embodiments of the present disclosure described herein provide an improved information processing system, information processing apparatus, and information processing method. The information processing system including an information processing apparatus and a plurality of terminals connected to the information processing apparatus determines, in response to a request sent from one of the terminals to a first address to start an electronic meeting, which one of personal content for each terminal and shared content shared between the terminals to display on the terminal that accessed the first address; and redirects the terminal that accessed the first address to one of a second address of the personal content and a third address of the shared content, according to a determination result.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating examples of a shared board and personal boards;

FIG. 2 is a diagram illustrating an example of an overall configuration of a meeting service system, according to a first embodiment of the present disclosure;

FIG. 3 is a diagram illustrating an example of an overview of access to a board, according to embodiments of the present disclosure;

FIG. 4 is a block diagram illustrating an example of a hardware configuration of a computer, according to embodiments of the present disclosure;

FIG. 5 is a diagram illustrating an example of a functional configuration of the meeting service system, according to the first embodiment of the present disclosure;

FIG. 6A and FIG. 6B are diagrams each illustrating an example of a board management table, according to embodiments of the present disclosure;

FIG. 7 is a diagram illustrating an example of a shared terminal management table, according to embodiments of the present disclosure;

FIG. 8 is a sequence diagram illustrating an example of a process of starting a meeting using the shared terminal according to the first embodiment of the present disclosure;

FIG. 9 is a diagram illustrating an example of a floating bar, according to embodiments of the present disclosure;

FIG. 10 is a diagram illustrating an example of a guidance screen, according to embodiments of the present disclosure;

FIG. 11 is a diagram illustrating an example of a shared board screen, according to embodiments of the present disclosure;

FIG. 12 is a sequence diagram illustrating an example of a process of starting a meeting using a personal terminal according to the first embodiment of the present disclosure;

FIG. 13 is a sequence diagram illustrating an example of a process of closing a meeting, according to the first embodiment of the present disclosure;

FIG. 14 is a diagram illustrating relation between the shared board and the personal board, according to embodiments of the present disclosure;

FIG. 15 is a flowchart illustrating a first example of a registration process of a shared terminal IP address according to the first embodiment of the present disclosure;

FIG. 16 is a diagram illustrating an example of a shared terminal IP address registration screen, according to embodiments of the present disclosure;

FIG. 17 is a sequence diagram illustrating a second example of a registration process of a shared terminal IP address according to the first embodiment of the present disclosure;

FIG. 18A and FIG. 18B are sequence diagrams illustrating a first example of a process of starting a meeting using the shared terminal according to a second embodiment of the present disclosure;

FIG. 19 is a diagram illustrating an example of a board type selection screen;

FIG. 20A and FIG. 20B are sequence diagrams illustrating a second example of a process of starting a meeting using the shared terminal according to a second embodiment of the present disclosure;

FIG. 21 is a diagram illustrating an example of a functional configuration of the meeting service system, according to a third embodiment of the present disclosure;

FIG. 22 is a diagram illustrating an example of a communication method management table;

FIG. 23A and FIG. 23B are sequence diagrams illustrating an example of a process of starting a meeting using the shared terminal according to the third embodiment of the present disclosure;

FIG. 24A and FIG. 24B are sequence diagrams illustrating an example of a process of starting a meeting using a relay device according to the third embodiment of the present disclosure; and

FIG. 25A and FIG. 25B are sequence diagrams illustrating an example of a process of starting a meeting using the shared terminal according to a fourth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Embodiments of the present disclosure are described below with reference to the drawings. In each of the following embodiments, a meeting service system 1 which causes a terminal to access either personal content or shared content depending on whether the terminal participating in an electronic meeting is a “personal terminal” or a “shared terminal” is described. Here, the personal terminal is a terminal (for example, a personal computer (PC), a smartphone, a tablet terminal, a portable game device, etc.) that an individual uses alone. On the other hand, the shared terminal is a terminal (for example, an electronic whiteboard, a projector, etc.) that can be used by multiple people simultaneously. Note that the shared terminal may be, for example, a display device connected to a stick-type PC or the like.

Hereinafter, as an example, personal content is a personal board, and shared content is a shared board. Also, the personal board and the shared board may be collectively referred to as simply a “board”.

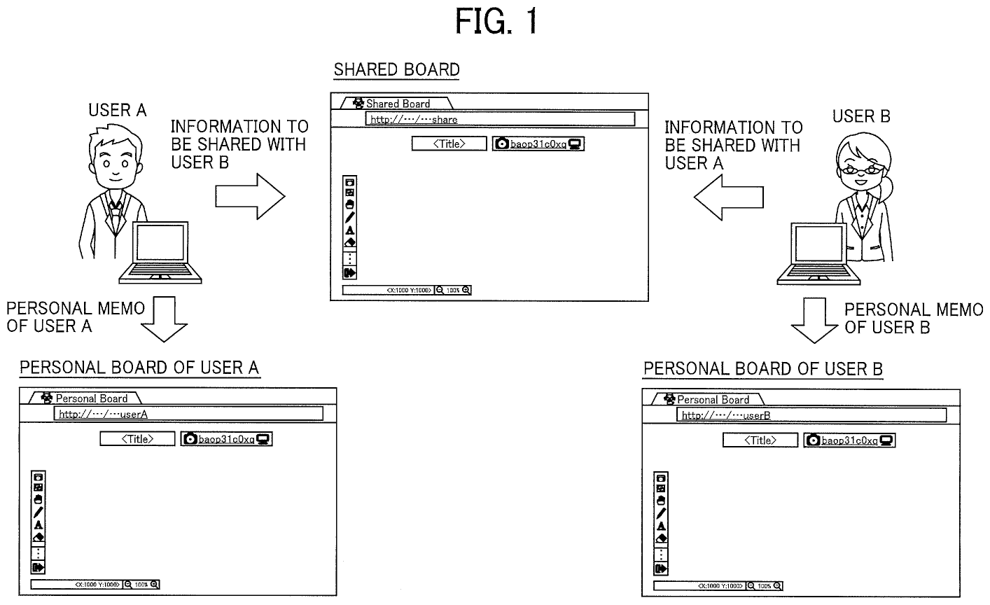

Referring to FIG. 1, the personal board and the shared board in the case where the user A and the user B conduct an electronic meeting using a personal terminal is described. FIG. 1 is a diagram illustrating examples of the personal boards and the shared board.

As illustrated in FIG. 1, one shared board is created for one electronic meeting. On the other hand, one personal board is created for each participant of the electronic meeting. In the example illustrated in FIG. 1, the personal board of the user A and the personal board of the user B are created.

The shared board is used to indicate information that the user A and the user B want to share. On the other hand, the personal board is used by the participants themselves to write personal notes and the like. In this manner, the shared board is used to, for example, describe information to be shared among the participants of the electronic meeting, whereas the personal board is used for each participant of the electronic meeting to write information such as their own personal notes. Therefore, when multiple people use the shared terminal simultaneously, it is preferable that the shared board is displayed on the shared terminal.

The personal content is not limited to the personal board but may be any content individually used by the participants of the electronic meeting. Similarly, the shared content is not limited to the shared board and may be any content shared and used by the participants of the electronic meeting. Examples of such content include data such as audio data, image data, and document data.

### First Embodiment

<Overview of Configuration>

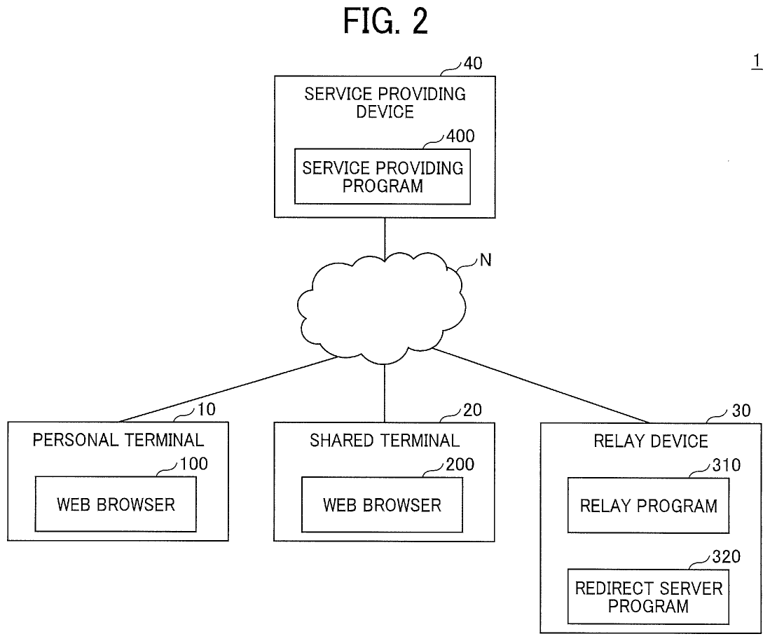

Hereinafter, a description is given of an overall configuration of the meeting service system 1 according to the present embodiment with reference to FIG. 2. FIG. 2 is a diagram illustrating an example of an overall configuration of the meeting service system 1, according to a first embodiment of the present disclosure.

As illustrated in FIG. 2, in the meeting service system 1 according to the present embodiment, one or more personal terminals 10, one or more shared terminals 20, one or more relay devices 30, and a service providing device 40 are included. The personal terminal 10, the shared terminal 20, the relay device 30, and the service providing device 40 are communicably connected through a communication network N such as the internet. The communication network N may be, for example, a local communication network such as an in-house network.

The personal terminal 10 is a personal terminal used by a participant of the electronic meeting. A web browser 100 is installed in the personal terminal 10. The user of the personal terminal 10 can use the web browser 100 to use the electronic meeting service (hereinafter, also simply referred to as “meeting service”) provided by the service providing device 40.

The user can use the personal board created by the service providing device 40 on the web browser 100. By using the personal board, the user of the personal terminal 10 can make a memo or the like regarding the meeting on the personal board. The user can also use the shared board created by the service providing device 40 on the web browser 100.

The shared terminal 20 is a shared terminal that one or more participants of the electronic meeting can use simultaneously. A web browser 200 is installed in the shared terminal 20. The user of the shared terminal 20 can use the web browser 200 to use the meeting service provided by the service providing device 40.

The user can use the shared board created by the service providing device 40 on the web browser 200. By using the shared board, each user of the shared terminal 20 can write information or the like to be shared with other users of the shared board. Each user of the shared terminal 20 can also display, for example, material relating to the electronic meeting on the shared board, and write down characters, symbols, and the like with an electronic pen or the like on the material.

Whether a certain terminal is used as the personal terminal 10 or as the shared terminal 20 is determined by the type of the terminal, for example. As described above, when the terminal is a PC, a smartphone, a tablet terminal or the like, the terminal is often used as the personal terminal 10. On the other hand, when the terminal is an electronic whiteboard, a projector or the like, the terminal is often used as the shared terminal 20. However, a certain terminal may be used as a personal terminal 10 in a certain electronic meeting and may be used as a shared terminal 20 in another electronic meeting.

The relay device 30 is a computer or computer system that relays between the personal terminal 10 and the shared terminal 20 and the service providing device 40 when starting the electronic meeting using the meeting service. The relay device 30 is installed, for example, in a room or space such as an actual meeting room and displays a Uniform Resource Locator (URL) for starting the electronic meeting by the meeting service. The URL is preferably a short, simple URL.

The personal terminal 10 and the shared terminal 20 can start the electronic meeting using the meeting service by inputting the above-mentioned URL to the web browser 100 and the web browser 200, respectively. Although one relay device 30 may be provided for one service providing device 40, it is generally assumed that a plurality of relay devices 30 exist.

A relay program 310 and a redirect server program 320 are installed in the relay device 30.

For example, when the personal terminal 10 or the shared terminal 20 starts the electronic meeting, the relay program 310 of the relay device 30 requests the service providing device 40 to create a board (personal board or shared board) used by the user of the personal terminal 10 or the shared terminal 20. Then, the redirect server program 320 of the relay device 30 redirects the personal terminal 10 or the shared terminal 20 to the board created by the service providing device 40. Thus, when the shared terminal 20 starts the electronic meeting using the meeting service, the shared board is displayed on the web browser 200 of the shared terminal 20. On the other hand, when the personal terminal 10 starts the electronic meeting using the meeting service, a personal board is displayed on the web browser 100 of the personal terminal 10.

Thus, the user of the personal terminal 10 can easily access the personal board used in the electronic meeting by inputting the URL displayed on the relay device 30 (a short and simple URL) on the web browser 100. Similarly, the user of the shared terminal 20 can simply enter the URL displayed on the relay device 30 (a short and simple URL) on the web browser 200, and the user can easily access the shared board for the electronic meeting.

Here, redirection is to automatically transfer to another connection destination. Note that this does not only mean forwarding to a specific other web page when access to a specific URL is accepted, but also includes transferring to any web page among a plurality of web pages determined according to various conditions.

Any device (for example, a PC, an electronic whiteboard, a display, a digital signage, a projector, etc.) in which the relay program 310 and the redirect server program 320 are installed can be used as the relay device 30. Further, a given apparatus may be both the relay device 30 and the shared terminal 20.

The service providing device 40 is a computer or computer system that provides the meeting service, for example, in the form of a cloud service. The service providing device 40 has a service providing program 400 installed. The service providing device 40 creates a shared board and a personal board by the service providing program 400 in response to a request from the relay device 30.

Further, the service providing device 40 performs various processes (for example, synchronization between the personal terminal 10 and the shared terminal 20 of the meeting participants) by the service providing program 400 to implement the meeting service.

The configuration of the meeting service system 1 illustrated in FIG. 2 is but an example, and another, different configuration is acceptable. For example, the meeting service system 1 may include a plurality of service providing devices 40.

<Overview of Access to the Board>

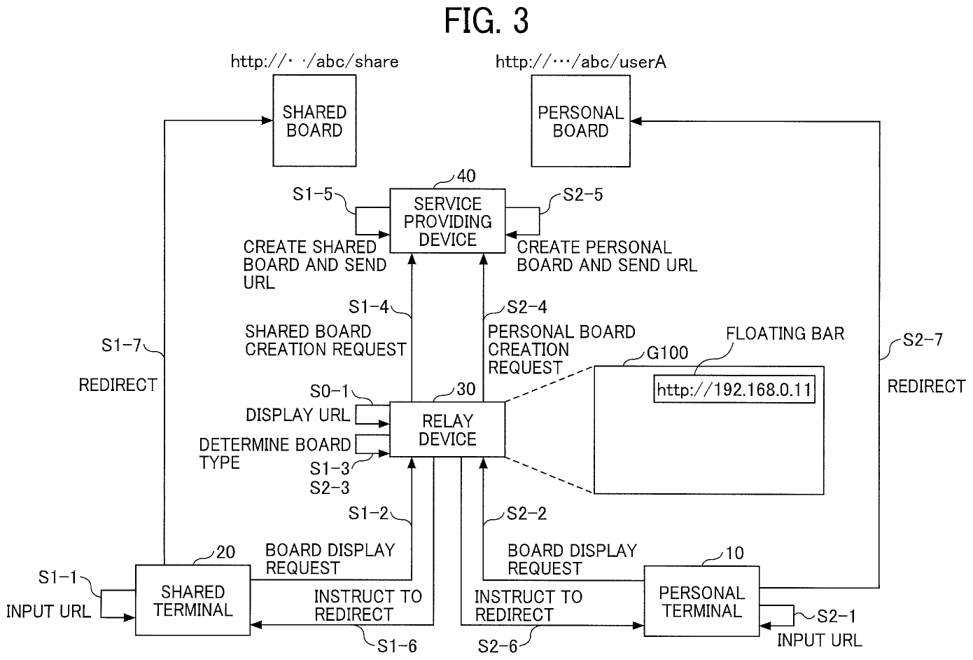

Here, as an example, an outline when the shared terminal 20 accesses the shared board and the personal terminal 10 accesses the personal board, when the user of the shared terminal 20 and the user of the personal terminal 10 start the electronic meeting, is described with reference to FIG. 3. In FIG. 3, it is assumed that the shared board accessed by the shared terminal 20 and the personal board accessed by the personal terminal 10 are not created.

In step S0-1, the relay program 310 of the relay device 30 displays a screen G100 including a floating bar. The floating bar is a display component on which a URL for starting the electronic meeting using the meeting service is displayed. The screen G100 is displayed, for example, when the relay device 30 is activated.

The URL is a URL indicating the relay device 30 (more precisely, a URL indicating a web server implemented by the redirect server program 320 of the relay device 30). The URL is preferably short and simple. Hereinafter, the URL included in the floating bar is also referred to as a “shortened URL” as a short and simple expression. At the same time, the shortened URL does not necessarily need to be a short and simple URL. For example, the shortened URL may be a URL easy for the user to remember, a URL easy to input, or the like.

In step S1-1, the user of the shared terminal 20 inputs the shortened URL contained in the floating bar into the web browser 200. For example, the user of the shared terminal 20 inputs the shortened URL “192.168.0.11” into the web browser 200.

In step S1-2, the web browser 200 of the shared terminal 20 transmits a board display request to the shortened URL (that is, the relay device 30) input in step S1-1.

In step S1-3, when the redirect server program 320 receives the board display request, the relay device 30 determines the type of board to be displayed at the request source of the board display request (hereinafter simply referred to as “board type”). The board type is information indicating whether the board is the personal board or the shared board. For example, when an internet protocol (IP) address of the request source of the board display request is the IP address of the shared terminal 20, the board type is determined to be “shared board”. On the other hand, for example, when the IP address of the request source of the board display request is other than the IP address of the shared terminal 20, the board type is determined to be “personal board”.

Here, since the request source of the board display request is the shared terminal 20, the board type is determined to be “shared board” in step S1-3 described above. Therefore, hereinafter, the description continues on the assumption that the board type is determined to be the “shared board” in step S1-3 described above.

In step S1-4, when the relay device 30 determined that the board type is “shared board”, the relay program 310 of the relay device 30 transmits a shared board creation request to the service providing device 40.

In step S1-5, when the service providing device 40 receives the shared board creation request, the service providing program 400 creates a shared board and sends back a URL for accessing the shared board to the relay device 30. The shared board is stored in an auxiliary storage device or the like of the service providing device 40.

In step S1-6, the redirect server program 320 of the relay device 30 instructs the shared terminal 20 to redirect to the URL for accessing the shared board.

In step S1-7, the shared terminal 20 redirects to the shared board. As a result, the shared board is displayed on the web browser 200 of the shared terminal 20. That is, the shared terminal 20 can access the shared board in response to the start of the electronic meeting.

In step S2-1, the user of the personal terminal 10 inputs the shortened URL contained in the floating bar into the web browser 100. For example, the user of the personal terminal 10 inputs the shortened URL “192.168.0.11” to the web browser 100 in the same manner as the user of the shared terminal 20.

In step S2-2, the personal terminal 10 transmits a board display request to the shortened URL input in step S2-1 by the web browser 100.

In step S2-3, the relay device 30 determines the board type to be displayed at the request source of the board display request when the redirect server program 320 receives the board display request, as in step S1-3 described above.

Here, since the request source of the board display request is the personal terminal 10, the board type is determined to be “personal board” in step S2-3. Therefore, hereinafter, the description continues on the assumption that the board type is determined to be the “personal board” in step S2-3 above.

In step S2-4, when the board type is determined to be “personal board”, the relay program 310 of the relay device 30 transmits a personal board creation request to the service providing device 40.

In step S2-5, when the service providing device 40 receives the personal board creation request, the service providing program 400 creates a personal board to be used by the user of the personal terminal 10 and sends a URL for accessing the personal board to the relay device 30. The personal board is stored in an auxiliary storage device or the like of the service providing device 40.

In step S2-6, the redirect server program 320 of the relay device 30 instructs the personal terminal 10 to redirect to a URL for accessing the personal board.

In step S2-7, the personal terminal 10 redirects to its own personal board. As a result, the personal board for the user of the personal terminal 10 is displayed on the web browser 100 of the personal terminal 10. That is, the personal terminal 10 can access the personal board for the user of the personal terminal 10 at the start of the electronic meeting.

As described above, the user of the shared terminal 20 inputs the shortened URL (for example, “192.168.0.11”) displayed on the relay device 30 into the web browser 200 to create and easily access the shared board. On the other hand, the user of the personal terminal 10 inputs the shortened URL displayed on the relay device 30 into the web browser 100, to create and easily access the personal board.

As described above, the meeting service system 1 according to the present embodiment redirects the personal terminal 10 to the personal board when the personal terminal 10 starts the electronic meeting. On the other hand, when the electronic meeting is started by the shared terminal 20, the shared terminal 20 is redirected to the shared board. For example, when multiple users use the shared terminal 20 in the electronic meeting, the shared board can be displayed on the shared terminal 20 according to the meeting service system 1 of the present embodiment.

In the example illustrated in FIG. 3, a shared board has not been created. However, for example, when the shared board has been created already, creation of the shared board is not performed as described below. In this example, the shared board is not created at step S1-5 above, and the shared terminal 20 is redirected to the shared board created at step S1-6 above.

Similarly, if a personal board has already been created, the personal board is not created. In this case, the personal board is not created in step S2-5 above, and the personal terminal 10 is redirected to the personal board created in step S2-6 above.

Thus, for example, even when the display of the shared board on the web browser 200 is closed in the middle of the electronic meeting, the display of the shared board can be easily resumed by inputting the shortened URL displayed on the relay device 30 to the web browser 200 again. Similarly, for example, even when the display of the personal board on the web browser 100 is closed in the middle of the electronic meeting, the display of the personal board can be easily resumed by inputting the shortened URL displayed on the relay device 30 to the web browser 100 again.

<Hardware Configuration>

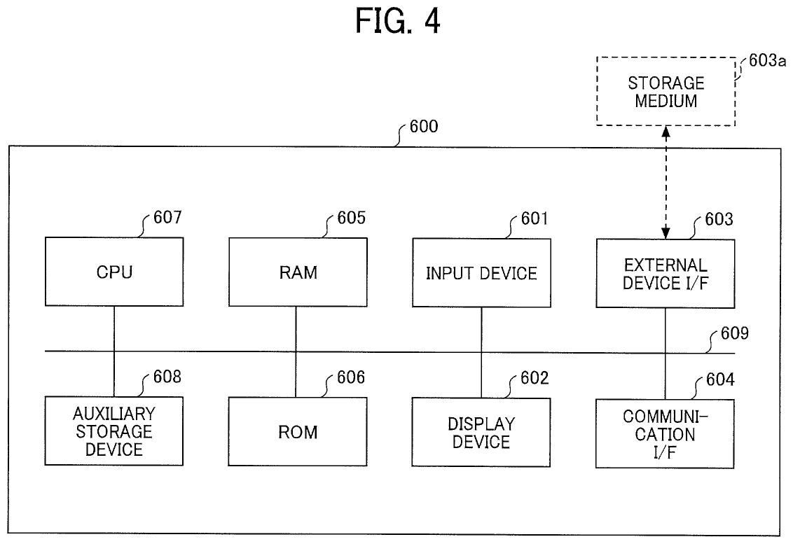

The hardware configuration of the personal terminal 10, the shared terminal 20, the relay device 30, and the service providing device 40 according to the present embodiment is described. The personal terminal 10, the shared terminal 20, the relay device 30, and the service providing device 40 according to the present embodiment can be implemented, for example, by the hardware configuration of a computer 600 illustrated in FIG. 4. FIG. 4 is a block diagram illustrating an example of a hardware configuration of the computer 600, according to the present embodiment.

The computer 600 illustrated in FIG. 4 includes an input device 601, a display device 602, an external device interface (I/F) 603, a communication I/F 604, a random access memory (RAM) 605, a read only memory (ROM) 606, a central processing unit (CPU) 607 and an auxiliary storage device 608. These hardware components are communicably connected to each other through a bus 609.

The input device 601 includes, for example, a keyboard, a mouse, a touch panel, and the like, and is used by the user to perform various operations. The display device 602 is, for example, a display and displays a processing result of the computer 600. Note that the service providing device 40 may not have at least one of the input devices 601 and the display device 602.

The external device I/F 603 is an interface with an external device. The external device is, for example, a storage medium 603a. The computer 600 can read from and write to the storage medium 603a through the external device I/F 603. Examples of the storage medium 603a include a secure digital (SD) memory card, a universal serial bus (USB) memory, a compact disk (CD), a digital versatile disk (DVD), and the like.

The communication I/F 604 is an interface for connecting the computer 600 to the communication network N. The RAM 605 is a volatile semiconductor memory that temporarily holds programs and data. The ROM 606 is a nonvolatile semiconductor memory that can retain data even after the power is turned off.

The CPU 607 reads programs or data from a storage device such as the ROM 606 or the auxiliary storage device 608 onto the RAM 605 and executes processing according to the read-out program or data, to control entire operation of the computer 600 or implement functions of the computer 600.

The auxiliary storage device 608 is, for example, a hard disk drive (HDD) or a solid state drive (SSD) and is a nonvolatile storage device storing programs and data. The auxiliary storage device 608 includes, for example, an operating system (OS) which is the basic software for controlling the entire computer 600, and application software for providing various functions on the OS. Further, in the auxiliary storage device 608 of the personal terminal 10, a web browser 100 is stored. Similarly, a web browser 200 is stored in the auxiliary storage device 608 of the shared terminal 20. Also, in the auxiliary storage device 608 of the relay device 30, a relay program 310 and a redirect server program 320 are stored. In addition, a service providing program 400 is stored in the auxiliary storage device 608 of the service providing device 40.

The personal terminal 10, the shared terminal 20, the relay device 30, and the service providing device 40 according to the present embodiment can implement various processes according to the present embodiment by the hardware configuration of the computer 600 illustrated in FIG. 4. The personal terminal 10, the shared terminal 20, the relay device 30, and the service providing device 40 according to the present embodiment may be implemented by the hardware configuration of a plurality of computers 600.

<Functional Configuration>

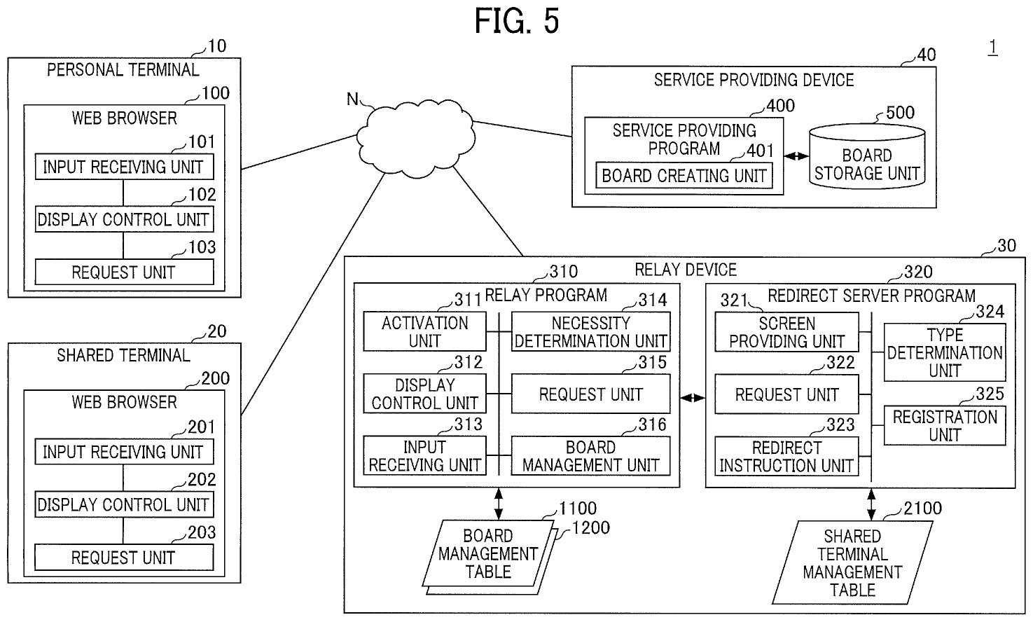

Hereinafter, a description is given of a functional configuration of the meeting service system 1 according to the present embodiment with reference to FIG. 5. FIG. 5 is a diagram illustrating an example of a functional configuration of the meeting service system 1, according to the first embodiment of the present disclosure.

Personal Terminal 10

As illustrated in FIG. 5, the personal terminal 10 according to the present embodiment includes an input receiving unit 101, a display control unit 102, and a request unit 103. These units are implemented by processing that the web browser 100 causes the CPU to execute. In particular, when the web browser 100 causes the CPU to execute processing related to web content, all or part of the processing performed by each of the units is implemented. Note that the web content is various data acquired from a web server (or a program that functions as a web server). For example, Hyper Text Markup Language (HTML), Cascading Style Sheets (CSS), JavaScript (registered trademark), etc. may be mentioned.

The input receiving unit 101 receives various inputs (for example, input of a URL, etc.) by the user. The display control unit 102 displays various screens (for example, a screen including a personal board (hereinafter also referred to as personal board screen)). The request unit 103 transmits various requests (for example, a personal board display request and the like).

Shared Terminal 20

As illustrated in FIG. 5, the shared terminal 20 according to the present embodiment includes an input receiving unit 201, a display control unit 202, and a request unit 203. These units are implemented by processing that the web browser 200 causes the CPU to execute. In particular, when the web browser 200 causes the CPU to execute processing related to web content, all or part of the processing performed by each of the units is implemented.

The input receiving unit 201 receives various inputs (for example, input of a URL, etc.) by the user. The display control unit 202 displays various screens (for example, a screen including a shared board (hereinafter also referred to as “shared board screen”)). The request unit 203 transmits various requests (for example, a shared board display request and the like).

Relay Device 30

As illustrated in FIG. 5, the relay device 30 according to the present embodiment includes an activation unit 311, a display control unit 312, an input receiving unit 313, a necessity determination unit 314, a request unit 315, and a board management unit 316. These units are implemented by processing that the relay program 310 causes the CPU to execute.

Also, the relay device 30 according to the present embodiment includes a screen providing unit 321, a request unit 322, a redirect instruction unit 323, a type determination unit 324, and a registration unit 325. These units are implemented by processing that the redirect server program 320 causes the CPU to execute. However, the type determination unit 324 and the registration unit 325 may be implemented by processing that a program different from the relay program 310 and the redirect server program 320 causes the CPU to execute.

The activation unit 311 activates the redirect server program 320, for example, in response to activation of the relay device 30 or the like.

The display control unit 312 displays various screens (for example, a screen including a floating bar). The input receiving unit 313 receives various inputs (for example, pressing of a meeting close button described below) by the user.

The necessity determination unit 314 determines necessity of creating a shared board with reference to the board management table 1100. Further, the necessity determination unit 314 refers to the board management table 1200 to determine necessity of creating the personal board of the corresponding user (user of the personal terminal 10).

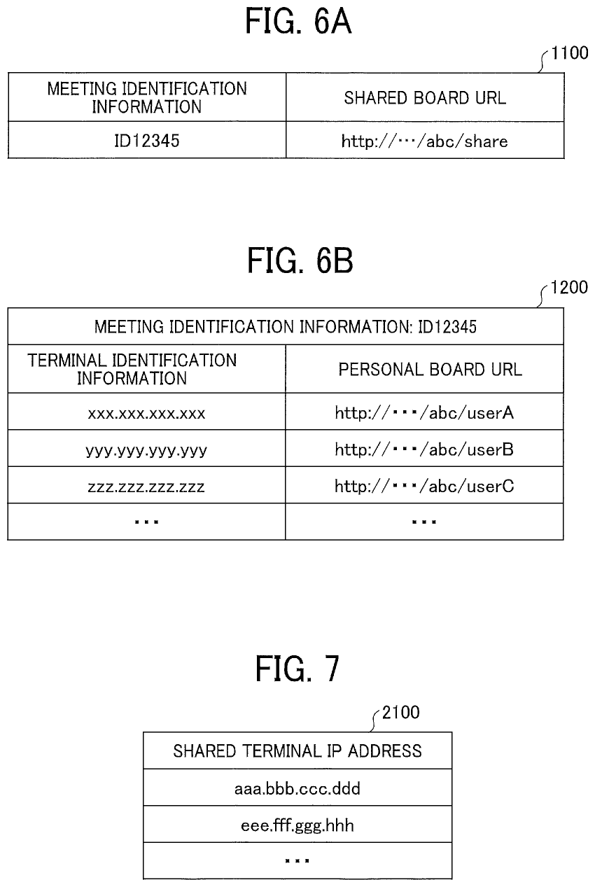

The board management tables 1100 and 1200 are tables for managing the URLs of the shared board and the personal board respectively. These tables are stored, for example, in an auxiliary storage device or the like. The board management tables 1100 and 1200 are described with reference to FIG. 6A and FIG. 6B. FIG. 6A and FIG. 6B are diagrams each illustrating an example of the board management tables 1100 and 1200.

As illustrated in FIG. 6A, the board management table 1100 includes meeting identification information and a shared board URL. The meeting identification information is information for identifying one electronic meeting and is generated when a shared board is created as described below. The shared board URL is a URL to access the shared board.

As described above, when a shared board is created, the board management table 1100 stores meeting identification information and a URL to access the shared board in association with each other.

Further, as illustrated in FIG. 6B, the board management table 1200 includes meeting identification information, terminal identification information, and a personal board URL. The meeting identification information is information for identifying the electronic meeting. The terminal identification information is information for identifying the personal terminal 10, and is, for example, an IP address of the personal terminal 10 or the like. However, any information that can identify the personal terminal 10 (for example, a serial number of the personal terminal 10 or the like) can be used as the terminal identification information.

The personal board URL is a URL for accessing the personal board used by the user of the personal terminal 10 identified by the terminal identification information.

In the board management table 1200, when a personal board is created by the personal terminal 10, the meeting identification information, the terminal identification information of the personal terminal 10, and the URL for accessing the personal board are stored in association with each other.

The necessity determination unit 314 determines that the shared board is not required to be created, for example, when the shared board URL is stored in the board management table 1100. Similarly, the necessity determination unit 314 determines that creation of the personal board for a user is not necessary, for example, when the terminal identification information for identifying the personal terminal 10 of the corresponding user and the personal board URL are stored in the board management table 1200.

The request unit 315 transmits various requests (for example, a shared board creation request, a personal board creation request, and the like).

The board management unit 316 manages the board management tables 1100 and 1200. When the shared board or the personal board is created by the service providing device 40, the board management unit 316 updates the board management table 1100 and the board management table 1200.

The screen providing unit 321 provides various screens (for example, a guidance screen described below) to the personal terminal 10 and the shared terminal 20. The request unit 322 requests the relay program 310 to create a shared board or a personal board in response to a request from the personal terminal 10 and the shared terminal 20. The redirect instruction unit 323 transmits a redirect instruction to the personal board screen to the personal terminal 10 and transmits a redirect instruction to the shared board screen to the shared terminal 20.

The type determination unit 324 refers to the shared terminal management table 2100 to determine the board type of the board to be accessed by the request source of the board display request.

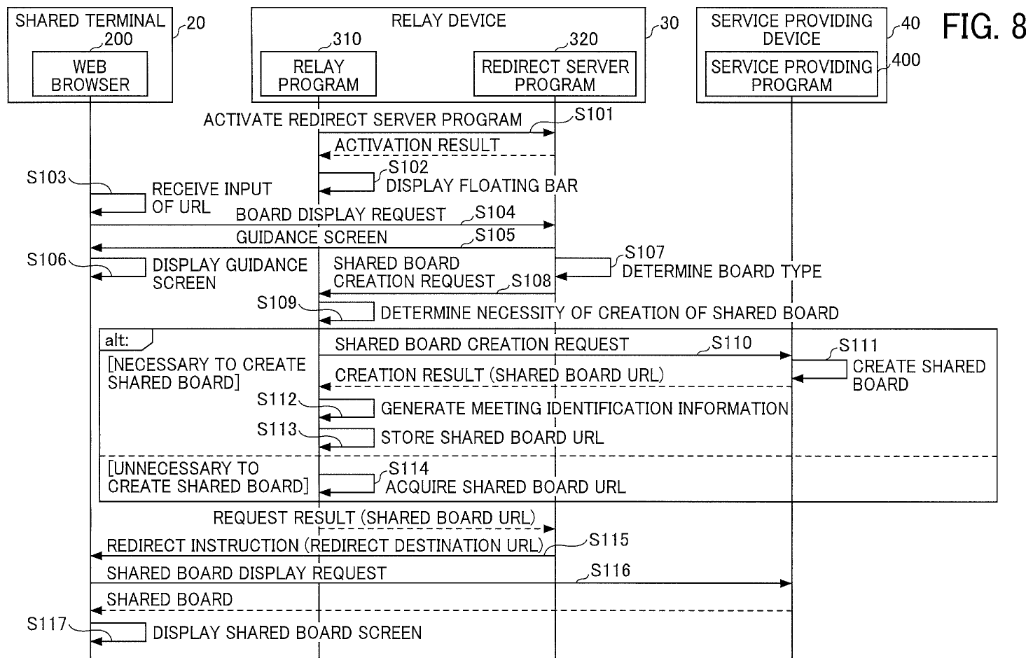

The shared terminal management table 2100 is a table for managing the IP address of the shared terminal 20. The shared terminal management table 2100 is stored, for example, in an auxiliary storage device or the like. The shared terminal management table 2100 is described with reference to FIG. 7. FIG. 7 is a diagram illustrating an example of the shared terminal management table 2100.

As illustrated in FIG. 7, the shared terminal management table 2100 includes a shared terminal IP address. The shared terminal IP address is the IP address of the shared terminal 20.

The shared terminal management table 2100 stores the IP address of the shared terminal 20. When the IP address of the request source of the board display request is stored as the shared terminal IP address, the type determination unit 324 determines the board type to be “shared board” with reference to the shared terminal management table 2100. On the other hand, when the IP address of the request source of the board display request is not stored as the shared terminal IP address, the type determination unit 324 determines that the board type is “personal board”.

In the example illustrated in FIG. 7, the IP address of the shared terminal 20 is stored. However, the present disclosure is not limited to this example and any identification information for identifying the shared terminal 20 may be stored. As such identification information, for example, a serial number of the shared terminal 20 and the like can be used.

The registration unit 325 stores the shared terminal IP address in the shared terminal management table 2100 according to the operation of the user of the relay device 30 or the like.

Service Providing Device 40

As illustrated in FIG. 5, the service providing device 40 according to the present embodiment has a board creating unit 401. The board creating unit 401 is implemented by processing that the service providing program 400 causes the CPU to execute.

Further, the service providing device 40 according to the present embodiment has a board storage unit 500. The board storage unit 500 can be implemented, for example, using an auxiliary storage device or the like. The board storage unit 500 may be implemented using a storage device or the like connected to the service providing device 40 through the communication network N.

The board creating unit 401 creates a shared board or a personal board in response to a request from the relay device 30. Also, the board creating unit 401 stores the created shared board and personal board in the board storage unit 500.

<Details of Processing>

Details of processing of the meeting service system 1 according to the present embodiment are described below.

Meeting Start Process Using Shared Terminal 20

In the following, a process of starting an electronic meeting using the shared terminal 20 in the meeting service system 1 according to the present embodiment is described with reference to FIG. 8. FIG. 8 is a sequence diagram illustrating an example of the process of starting the electronic meeting using the shared terminal 20 according to the present embodiment.

In step S101, the activation unit 311 of the relay program 310 activates the redirect server program 320 in response to activation of the relay device 30 or the like. When the redirect server program 320 is activated, the relay device 30 functions as a web server by the redirect server program 320. The redirect server program 320 sends back the activation result to the relay program 310.

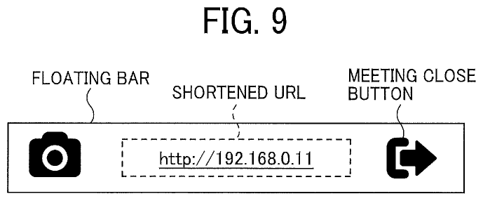

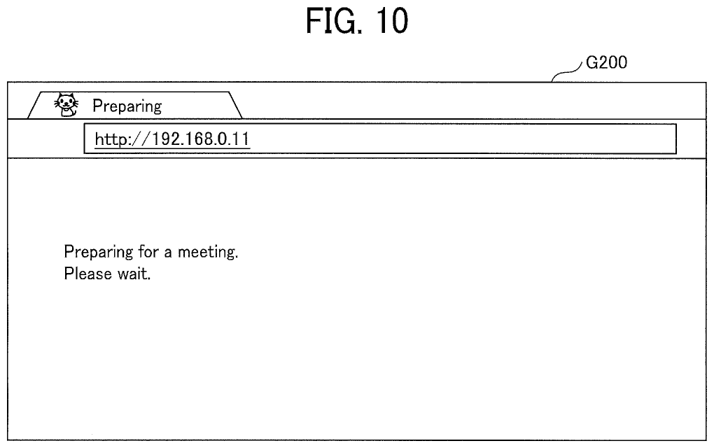

In step S102, the display control unit 312 of the relay program 310 displays the floating bar including the shortened URL on the screen. As a result, the relay device 30 displays the shortened URL for starting the electronic meeting. An example of the floating bar is illustrated in FIG. 9. As illustrated in FIG. 9, the floating bar displays the shortened URL for starting the electronic meeting. The floating bar also displays the meeting close button for closing the electronic meeting. As described below, when the user presses the meeting close button, the electronic meeting can be terminated.

Although the case where the shortened URL is displayed on the screen of the relay device 30 has been described, the present disclosure is not limited to this description. For example, on the screen of the relay device 30, a quick response (QR) code (registered trademark) or the like representing a shortened URL may be displayed. Further, on the screen of the relay device 30, for example, an image transmitted from the personal terminal 10 or the shared terminal 20 may be displayed as a shared screen together with the floating bar illustrated in FIG. 9. Alternatively, the shared board may be displayed on the screen of the relay device 30 together with the floating bar. When the shared board is displayed with the floating bar on the screen of the relay device 30, the shared board can also receive an operation from each personal terminal 10 (for example, handwriting input, character input, pasting of an image, etc.), an operation from each shared terminal 20, or an operation of the relay device 30.

Furthermore, the shortened URL is not limited to be displayed on the screen, and for example, a seal or the like on which the shortened URL is printed may be attached to a housing of the relay device 30.

Here, it is assumed that the user of the shared terminal 20 inputs, for example, the shortened URL in the address bar of the web browser 200. In step S103, the input receiving unit 201 of the web browser 200 receives an input of the shortened URL.

For example, when a plurality of relay devices 30 are respectively installed in a plurality of rooms or spaces, the plurality of relay devices 30 displays different shortened URLs. At this time, for example, when the shortened URL displayed by each relay device 30 is fixed, the shortened URL can be input from outside the room or space in which the relay device 30 is installed. For this reason, when the shortened URL is input in step S103 described above, an input of a different pass code or the like may be requested for each electronic meeting which has been started. Alternatively, for example, a shortened URL including a random number may be displayed in step S102 described above.

In step S104, the request unit 203 of the web browser 200 transmits a board display request to the relay device 30. The request unit 203 transmits the board display request to the relay device 30 by transmitting the board display request to the shortened URL address. The board display request includes the IP address of the shared terminal 20 as the transmission source IP address.

When receiving the board display request, the screen providing unit 321 of the redirect server program 320 transmits a guidance screen (more precisely, web content for displaying the guidance screen) to the shared terminal 20 in step S105.

In step S106, when receiving the guidance screen, the display control unit 202 of the web browser 200 displays, for example, a guidance screen G200 illustrated in FIG. 10. A guidance screen G200 illustrated in FIG. 10 is a screen displayed on the shared terminal 20 (and the personal terminal 10) until the electronic meeting by the meeting service is started. This is because the creation of a board (shared board or personal board) may require a certain length of time. The guidance screen G200 does not need to be displayed on the shared terminal 20 and the personal terminal 10 when preparation of a board does not require much time.

However, for example, the above-described guidance screen G200 may always be displayed on the shared terminal 20 (and the personal terminal 10) for a predetermined time. As a result, for example, security against an attack by brute force or the like in which a shared board URL or a personal board URL is found can be improved.

In step S107, the type determination unit 324 of the redirect server program 320 refers to the shared terminal management table 2100 to determine the board type of the board that the request source of the board display request in step S104 accesses. When the transmission source IP address included in the board display request is stored in the shared terminal management table 2100, the type determination unit 324 determines that the board type is “shared board”. On the other hand, when the transmission source IP address included in the board display request is not stored in the shared terminal management table 2100, the type determination unit 324 determines that the board type is “personal board”.

Hereinafter, the description continues on the assumption that the board type is determined to be “shared board” in the above-described step S107.

In step S108, when the board type is determined to be “shared board” in step S107, the request unit 322 of the redirect server program 320 transmits a shared board creation request to the relay program 310.

In step S109, the necessity determination unit 314 of the relay program 310 refers to the board management table 1100 to determine whether the shared board needs to be created. When the shared board URL is stored in the board management table 1100, the necessity determination unit 314 determines that creation of the shared board is unnecessary. On the other hand, when the shared board URL is not stored in the board management table 1100, the necessity determination unit 314 determines that the shared board needs to be created.

In step S110, when creation of a shared board is determined in step S109, the request unit 315 of the relay program 310 transmits a shared board creation request to the service providing device 40.

In step S111, when receiving the shared board creation request, the board creating unit 401 of the service providing program 400 creates a shared board. Then, the board creating unit 401 sends back a shared board URL to the relay device 30. The shared board is stored in the board storage unit 500.

In step S112, the board management unit 316 of the relay program 310 generates meeting identification information. In step S113, the board management unit 316 of the relay program 310 associates the meeting identification information generated in step S112 with the shared board URL returned from the service providing device 40 and stores the associated information in the board management table 1100.

In step S114, when creation of the shared board is determined unnecessary in step S109, the board management unit 316 of the relay program 310 acquires the shared board URL stored in the board management table 1100.

After step S113 or step S114, the relay program 310 returns the request result for the shared board creation request to the redirect server program 320. The request result includes the shared board URL. The shared board URL is the shared board URL returned from the service providing device 40 in step S111 described above or the shared board URL acquired in step S114 described above.

Thus, when the electronic meeting is started, and the shared board has not been created, the shared board is created. In the present embodiment, the shared board is created after the shortened URL is input into the web browser 200 of the shared terminal 20, but the creation timing of the shared board is not limited to this. The shared board may be created, for example, after the relay device 30 is activated, or the shared board for the next electronic meeting may be created after the previous electronic meeting is closed.

In step S115, the redirect instruction unit 323 of the redirect server program 320 transmits a redirect instruction with the shared board URL as a redirect destination URL to the shared terminal 20 (the request source of the board display request in step S104 above).

In step S116, the request unit 203 of the web browser 200 transmits a shared board display request to the redirect destination URL. Thereby, the shared board (more precisely, web content for displaying the shared board) is returned from the service providing device 40.

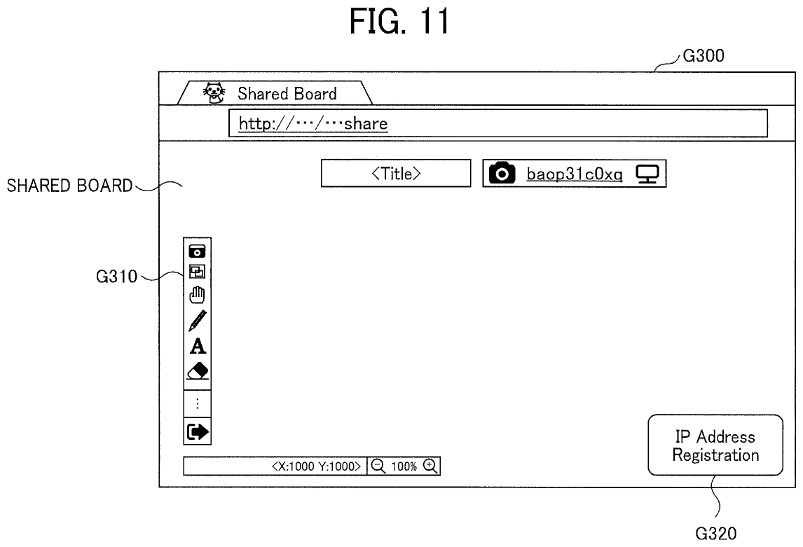

In step S117, when receiving the shared board, the display control unit 202 of the web browser 200 displays, for example, a shared board screen G300 illustrated in FIG. 11. A shared board is displayed on the shared board screen G300 illustrated in FIG. 11. Thereby, one or more users who simultaneously use the shared terminal 20 can conduct an electronic meeting using the shared board.

The shared board screen G300 illustrated in FIG. 11 includes a drawing tool selection field G310. The user can draw a character, a figure, or the like on the shared board by selecting a desired drawing tool (for example, a pen, a character input, etc.) from the drawing tool selection field G310. In addition, an image or the like can be pasted to the shared board, for example.

Further, the shared board screen G300 illustrated in FIG. 11 includes an IP address registration button G320. As described below, when the IP address registration button G320 is pressed by the user, the IP address of the shared terminal 20 can be registered (stored) in the shared terminal management table 2100.

As described above, in the meeting service system 1 according to the present embodiment, the user of the shared terminal 20 automatically redirects to the shared board when the shortened URL is input into the web browser 200. As a result, one or more users who simultaneously use the shared terminal 20 can participate in the electronic meeting using the shared board.

In the example illustrated in FIG. 8, the redirect server program 320 determines the board type (step S107), but this determination may be performed by the web browser 200 after step S103, for example. When the web browser 200 determines that the board type is “shared board”, the web browser 200 may transmit a shared board display request to the relay device 30 in step S104.

Meeting Start Process Using Personal Terminal 10

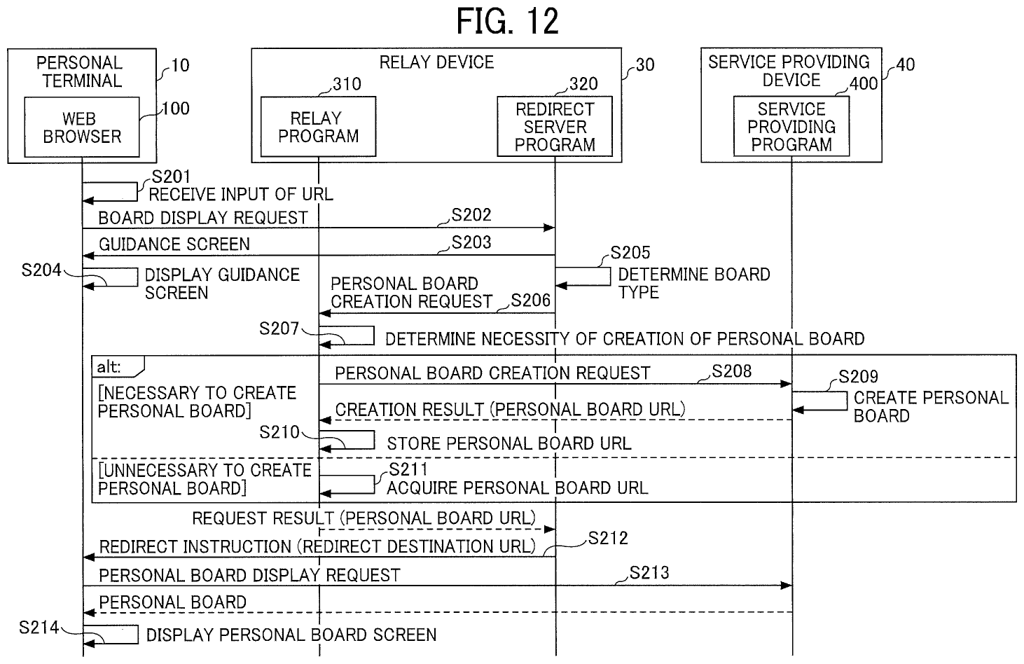

In the following, a process to start an electronic meeting using the personal terminal 10 in the meeting service system 1 according to the present embodiment is described with reference to FIG. 12. FIG. 12 is a sequence diagram illustrating an example of a process of starting a meeting using a personal terminal 10 according to the first embodiment of the present disclosure. In FIG. 12, it is assumed that steps S101 to S117 in FIG. 8 have been executed.

It is assumed that the user of the personal terminal 10 inputs the shortened URL in, for example, the address bar of the web browser 100. In step S201, the input receiving unit 101 of the web browser 100 receives an input of the shortened URL.

In step S202, the request unit 103 of the web browser 100 transmits a board display request to the relay device 30. The request unit 203 transmits the board display request to the relay device 30 by transmitting the board display request to the shortened URL address. The board display request includes the IP address of the personal terminal 10 as the transmission source IP address.

In step S203, when the screen providing unit 321 of the redirect server program 320 receives the board display request, the screen providing unit 321 transmits a guidance screen (more precisely, web content for displaying the guidance screen) to the personal terminal 10.

When the display control unit 102 of the web browser 100 receives the guidance screen, as in step S106 of FIG. 8, the display control unit 102 displays, for example, the guidance screen G200 illustrated in FIG. 10 in step S204.

In step S205, similar to step S107 of FIG. 8, the type determination unit 324 of the redirect server program 320 determines the board type of the board to be accessed by the request source of the board display request in step S202, referring to shared terminal management table 2100.

Hereinafter, the description continues on the assumption that the board type is determined to be “personal board” in step S205 described above.

In step S206, when the board type is determined to be “personal board” in step S205 described above, the request unit 322 of the redirect server program 320 transmits a personal board creation request to the relay program 310.

In step S207, the necessity determination unit 314 of the relay program 310 refers to the board management table 1200 to determine whether a personal board needs to be created. When the terminal identification information for identifying the personal terminal 10 that is the request source of the board display request in step S202 described above and the personal board URL are stored in the board management table 1200, the necessity determination unit 314 determines that the creation of personal board is unnecessary. On the other hand, when the terminal identification information and the personal board URL are not stored in the board management table 1200, the necessity determination unit 314 determines that the personal board needs to be created. The terminal identification information is, for example, the IP address of the personal terminal 10 as described above.

In step S208, the request unit 315 of the relay program 310 transmits a personal board creation request to the service providing device 40, when it is determined in step S207 that the personal board needs to be created.

In step S209, the board creating unit 401 of the service providing program 400 creates a personal board in response to receiving the personal board creation request. Then, the board creating unit 401 returns the personal board URL to the relay device 30. The personal board is stored in the board storage unit 500.

In step S210, the board management unit 316 of the relay program 310 associates meeting identification information stored in the board management table 1100, terminal identification information of the personal terminal 10 that is the request source of the board display request in step S202 above, and the personal board URL returned from the service providing device 40 and stores in the board management table 1200.

On the other hand, when it is determined in step S207 that the personal board is not required to be created, the board management unit 316 of the relay program 310 identifies the terminal of the personal terminal 10 that is the request source of the board display request in step S202. The personal board URL associated with the terminal identification information is acquired from the board management table 1200 in step S211.

After step S210 or step S211, the relay program 310 returns the request result for the personal board creation request to the redirect server program 320. The request result includes the personal board URL The personal board URL is the personal board URL returned from the service providing device 40 in step S209 described above or the personal board URL acquired in step S211 described above.

In step S212 the redirect instruction unit 323 of the redirect server program 320 transmits a redirect instruction with the personal board URL as the redirect destination URL to the personal terminal 10 (the request source of the board display request in step S202 above).

In step S213, the request unit 103 of the web browser 100 transmits a personal board display request to the redirect destination URL. As a result, the service providing device 40 sends back a personal board (more precisely, web content for displaying the personal board).

In step S214, the display control unit 102 of the web browser 100 displays a personal board screen when receiving the personal board. A personal board is displayed on this personal board screen. As a result, the user of the personal terminal 10 can participate in the electronic meeting using the personal board.

As described above, in the meeting service system 1 according to the present embodiment, when the user of the personal terminal 10 inputs the shortened URL into the web browser 100, the user is automatically redirected to the personal board. As a result, the user of the personal terminal 10 can participate in the electronic meeting using the personal board.

In the example illustrated in FIG. 12, the redirect server program 320 determines the board type (step S205), but this determination may be performed by the web browser 100 after step S201, for example. In this case, when the web browser 100 determines that the board type is “personal board”, the web browser 100 may transmit a personal board display request to the relay device 30 in step S202.

Meeting Termination Process

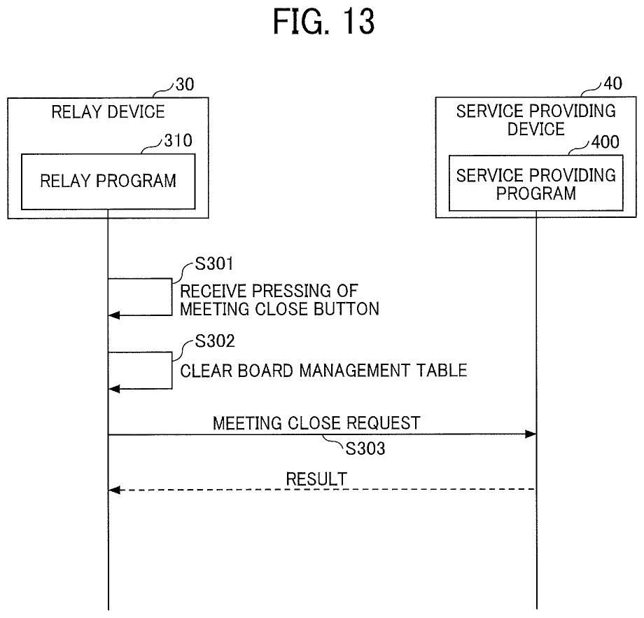

Hereinafter, a process in a case where the meeting service system 1 according to the present embodiment closes the electronic meeting is described with reference to FIG. 13. FIG. 13 is a sequence diagram illustrating an example of a process of closing a meeting, according to the first embodiment of the present disclosure.

For example, it is assumed that a participant of the electronic meeting has pressed (entered) the meeting close button of the floating bar displayed on the relay device 30. In step S301, the input receiving unit 313 of the relay program 310 receives an input of the meeting close button.

In step S302, the board management unit 316 of the relay program 310 clears the board management tables 1100 and 1200. That is, the board management unit 316 deletes the meeting identification information and the shared board URL stored in the board management table 1100. Further, the board management unit 316 deletes the meeting identification information, the terminal identification information, and the personal board URL stored in the board management table 1200.

In step S303, the request unit 315 of the relay program 310 transmits a meeting close request to the service providing device 40. In response to the meeting close request, the service providing device 40 returns a result for the meeting close request.

As described above, in the meeting service system 1 according to the present embodiment, the electronic meeting can be closed by pressing the meeting close button on the relay device 30. When the shortened URL is accessed from the personal terminal 10 after the meeting close button is pressed in the above-described meeting close process, the personal board before the meeting close button is pressed cannot be accessed, and a new personal board is created. Similarly, when the shortened URL is accessed from the shared terminal 20 after the meeting close button is pressed in the above-described meeting close process, the shared board before the meeting close button is pressed cannot be accessed, and a shared board is newly created

In the present embodiment, although the meeting close request in step S303 described above is transmitted from the relay device 30 to the service providing device 40, this step S303 need not be executed.

At this time, even when the electronic meeting is terminated, the shared board and the personal board used in the meeting are not deleted. Therefore, the user of the personal terminal 10 or the shared terminal 20 can display the shared board and the personal board used in the electronic meeting by entering the shared board URL or personal board URL in the web browser 100 or web browser 200.

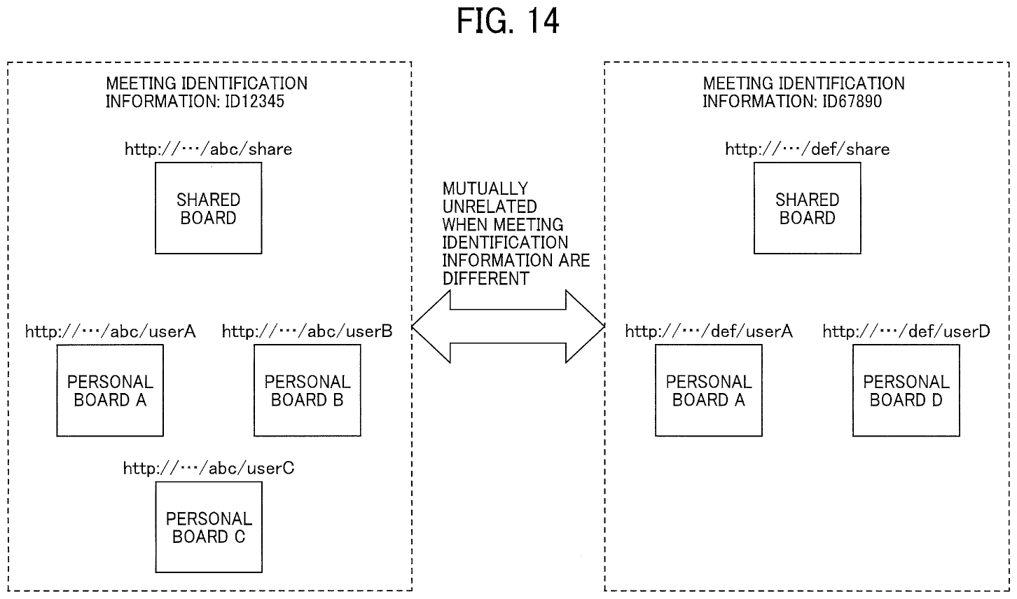

A relation between the shared board and the personal board is illustrated in FIG. 14.

As illustrated in FIG. 14, it is assumed that a personal board A, a personal board B and a personal board C are used in a certain electronic meeting (meeting identification information: ID12345) in addition to the shared board. Further, it is assumed that the electronic meeting whose meeting identification information is ID12345 is terminated, and subsequently a new electronic meeting whose meeting identification information is ID67890 is started, and a personal board A and a personal board D are used therewith as well as a shared board.

At this time, the shared board and the personal board used in the meeting identification information “ID12345” and the shared board and the personal board used in the meeting identification information “ID67890” are mutually unrelated. In other words, the URLs of these shared boards and personal boards are different.

For example, the URL of the shared board used by the meeting identification information “ID12345” and the URL of the shared board used by the meeting identification information “ID67890” are different. Similarly, for example, the URL of the personal board A used in the meeting identification information “ID12345” is different from the URL of the personal board A used in the meeting identification information “ID67890”.

An expiration date may be set on the shared board and the personal board. In this case, for example, after the end of the electronic meeting, when the expiration date has passed, the shared board and the personal board are deleted. Also, different expiration dates may be set for the shared board and the personal board.

First Shared Terminal IP Address Registration Process

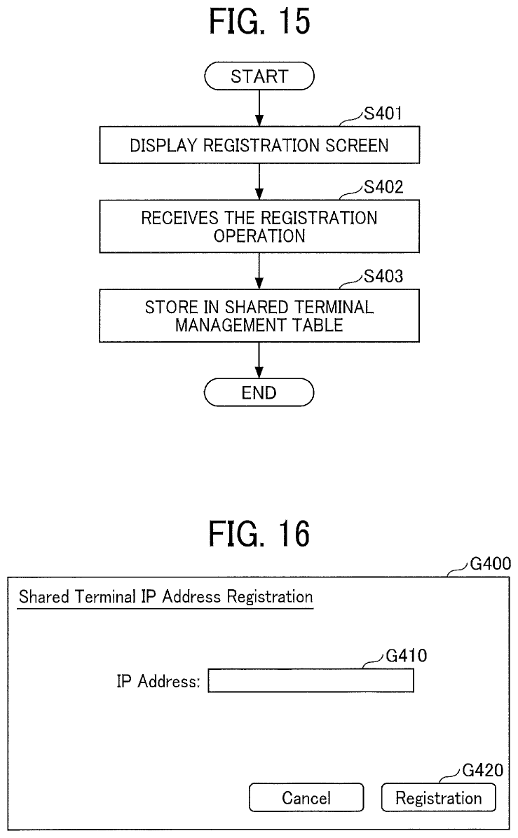

Hereinafter, a process in a case where the user operates the relay device 30 and registers the shared terminal IP address in the relay device 30 is described with reference to FIG. 15. FIG. 15 is a flowchart illustrating a first example of a registration process of a shared terminal IP address according to the first embodiment of the present disclosure.

In step S401, the display control unit 312 of the relay program 310 displays, for example, a shared terminal IP address registration screen G400 illustrated in FIG. 16 in response to a user operation. The shared terminal IP address registration screen G400 illustrated in FIG. 16 includes an IP address input field G410 and a registration button G420. The IP address input field G410 is an input field for inputting the IP address of the shared terminal 20.

The user inputs the IP address of the shared terminal 20 into the IP address input field G410, and presses the registration button G420, thereby performing the registration operation of the shared terminal IP address. Hereinafter, the description continues on the assumption that the registration operation of the shared terminal IP address is performed by the user.

In step S402, the input receiving unit 313 of the relay program 310 receives the registration operation of the shared terminal IP address.

In step S403, the registration unit 325 of the redirect server program 320 stores the IP address input by the registration operation of the shared terminal IP address as the shared terminal IP address in the shared terminal management table 2100. As a result, the IP address of the shared terminal 20 is registered in the relay device 30. Note that FIG. 15 describes a case where the IP address of the shared terminal 20 is registered in the relay device 30, but the user can also delete the IP address of the shared terminal 20 from the relay device 30. This may be performed, for example, by selecting the shared terminal IP address to be deleted from the list of registered shared terminal IP addresses, and the registration unit 325 may delete the selected shared terminal IP address.

Second Shared Terminal IP Address Registration Process

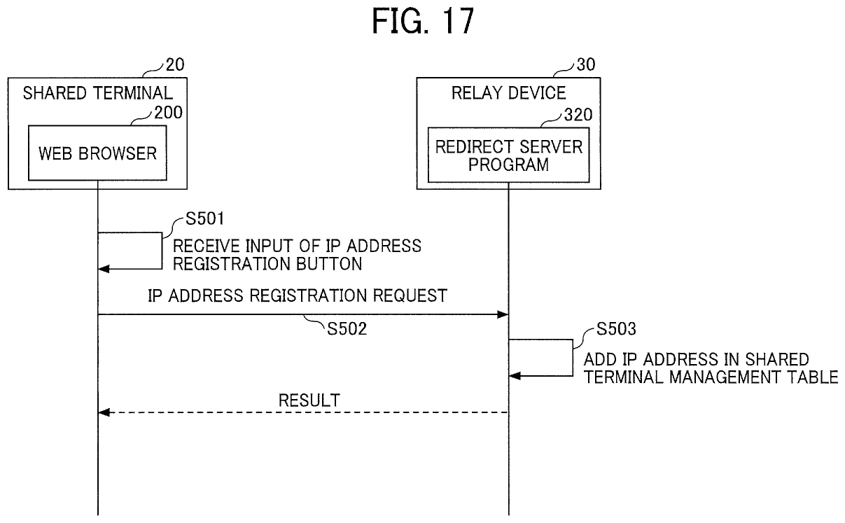

Hereinafter, a process when the IP address of the shared terminal 20 is registered in the relay device 30 as the shared terminal IP address by the user operating on the shared board screen displayed on the shared terminal 20 is described with reference to FIG. 17. FIG. 17 is a sequence diagram illustrating a second example of a registration process of a shared terminal IP address according to the first embodiment of the present disclosure. Hereinafter, it is assumed that the shared board screen G300 illustrated in FIG. 11 is displayed on the shared terminal 20 by the display control unit 202 of the web browser 200.

In the shared board screen G300 illustrated in FIG. 11, it is assumed that the user presses the IP address registration button G320. In step S501, the input receiving unit 201 of the web browser 200 receives the input.

In step S502, the request unit 203 of the web browser 200 transmits an IP address registration request to the relay device 30. The IP address registration request includes the IP address of the shared terminal 20.

In step S503, the registration unit 325 of the redirect server program 320 stores the IP address included in the registration request in the shared terminal management table 2100 as the shared terminal IP address, in response to receiving the IP address registration request. As a result, the IP address of the shared terminal 20 is registered in the relay device 30.

### Second Embodiment

Hereinafter, a description is given of a second embodiment of the present disclosure. In the first embodiment, the board type of the board to be displayed at the request source of the board display request is determined based on whether the IP address is stored in the shared terminal management table 2100 or not. In the second embodiment, the board type of the board to be displayed at the request source of the board display request is determined without using the shared terminal management table 2100.

Therefore, the relay device 30 according to the second embodiment may not have the shared terminal management table 2100.

In the following description of the second embodiment, basically only the differences from the first embodiment are described, and descriptions of the same components as the first embodiment are omitted or simplified as appropriate. Thus, in the second embodiment, a meeting start process using the shared terminal 20 is described, because processes other than the meeting start process using the shared terminal 20 are the same as in the first embodiment.

<Details of Processing>

Details of the processing of the meeting service system 1 according to the present embodiment are described.

First Meeting Start Process Using Shared Terminal 20

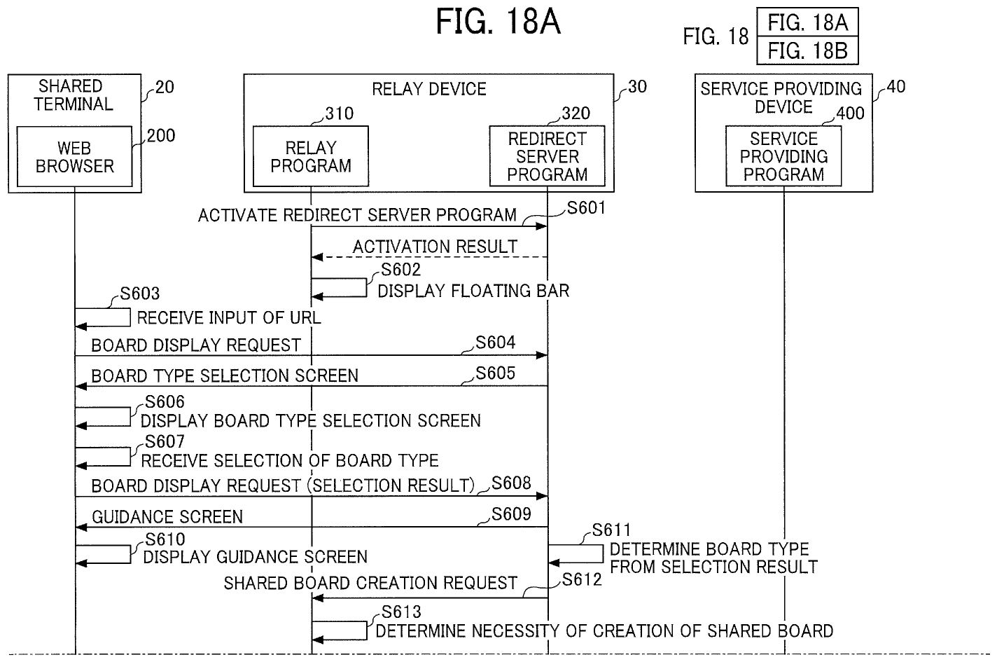

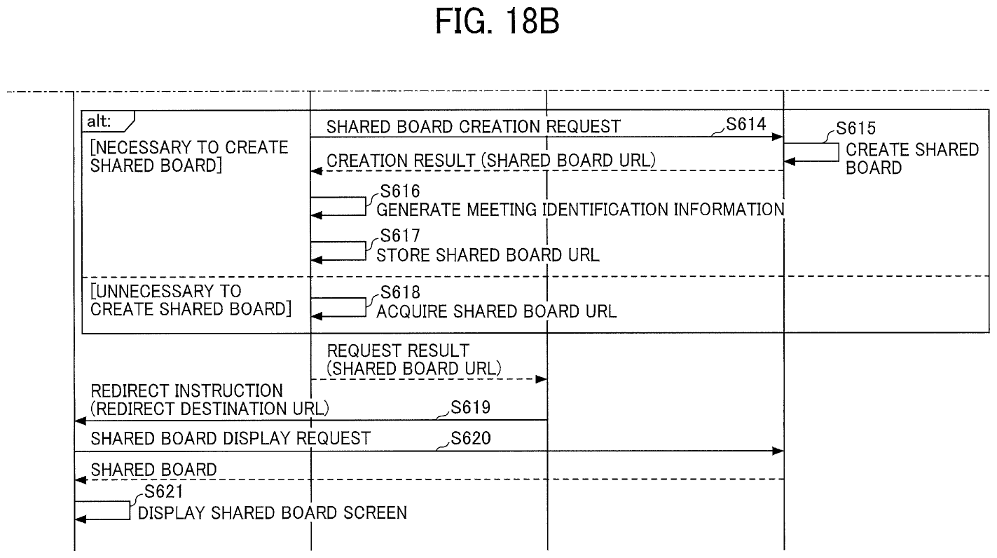

In the following, when starting the electronic meeting using the shared terminal 20, processing when the user selects the board type is described with reference to FIG. 18A and FIG. 18B. FIG. 18A and FIG. 18B are sequence diagrams illustrating a first example of a process of starting a meeting using the shared terminal according to the second embodiment. Steps S601 to S604 and steps S613 to S621 in FIG. 18 A and FIG. 18B are the same as steps S101 to S104 and steps S109 to S117 in FIG. 8.

Subsequent to step S604, the screen providing unit 321 of the redirect server program 320 transmits the board type selection screen (more precisely, the web content for displaying the selection screen of the board type) to the shared terminal 20 in step S605.

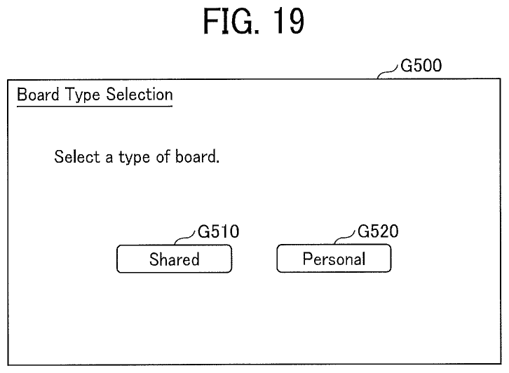

When receiving the board type selection screen, the display control unit 202 of the web browser 200 displays, for example, a selection screen G500 illustrated in FIG. 19 in step S606. The selection screen G500 illustrated in FIG. 19 is a screen for the user to select the board type. The selection screen G500 illustrated in FIG. 19 includes a shared button G510 and a personal button G520. The user can select a board type by pressing either the shared button G510 or the personal button G520. Hereinafter, it is assumed that the selection of the board type is made by the user. When the shared button G510 is pressed, the board type “shared board” is selected, and when the personal button G520 is pressed, the board type “personal board” is selected.

In step S607, the input receiving unit 201 of the web browser 200 receives the selection of the board type. In step S608, the request unit 203 of the web browser 200 transmits a board display request to the relay device 30. The board display request includes the selection result (“shared” or “personal”) selected by the selection of the board type.

In step S609, when receiving the board display request, the screen providing unit 321 of the redirect server program 320 transmits a guidance screen to the shared terminal 20.

In step S610, when the display control unit 202 of the web browser 200 receives the guidance screen as in step S106 of FIG. 8, the display control unit 202 displays, for example, the guidance screen G200 illustrated in FIG. 10.

In step S611, the type determination unit 324 of the redirect server program 320 determines the board type from the selection result included in the board display request from the shared terminal 20. The type determination unit 324 determines that the board type is “shared board” when the selection result is “shared” and determines the board type as “personal board” when the selection result is “personal”.

In the following, the description continues on the assumption that the board type is determined as “shared board” in step S611.

If the board type is determined to be “shared board” in step S611, the request unit 322 of the redirect server program 320 transmits a shared board creation request to the relay program 310 in step S612.

Although the example illustrated in FIG. 18 A and FIG. 18B illustrates a case where the user of the shared terminal 20 selects the board type, the user of the personal terminal 10 may similarly be able to select the board type.

As described above, in the meeting service system 1 according to the present embodiment, the shared terminal 20 (and the personal terminal 10) can be automatically redirected to the shared board or the personal board according to the selection of the user. When the user of the shared terminal 20 is redirected to the personal board, the personal board used by the user of the shared terminal 20 is created in the same manner as the personal terminal 10.

Thus, the user of the shared terminal 20 can selectively display either the shared board or the personal board at the start of the electronic meeting. Similarly, the user of the personal terminal 10 can also selectively display either the shared board or the personal board at the start of the electronic meeting.

The determination in step S611 in FIG. 18A may be performed by the web browser 200 (or the web browser 100).

Second Meeting Start Process Using Shared Terminal 20

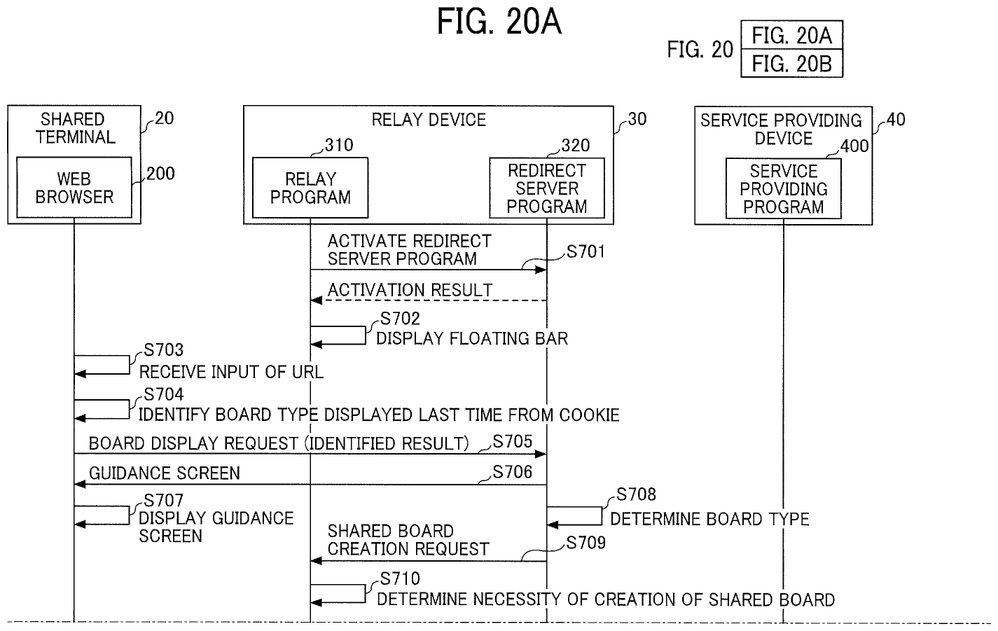

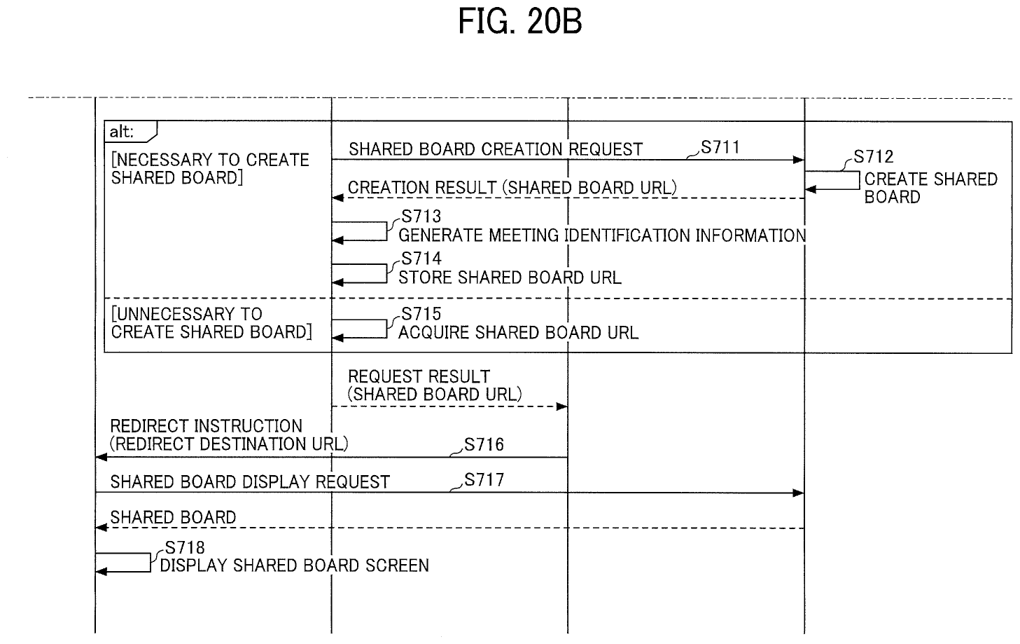

Hereinafter, a process of determining the board type from information recorded in a cookie of the web browser 200 when the electronic meeting is started using the shared terminal 20 is described with reference to FIG. 20A and FIG. 20B. FIG. 20A and FIG. 20B are sequence diagrams illustrating a second example of a process of starting a meeting using the shared terminal according to the second embodiment. Steps S701 to S703 and steps S710 to S718 in FIG. 20A and FIG. 20B are the same as steps S101 to S103 and steps S109 to S117 in FIG. 8, respectively, and thus the description thereof is omitted.

Following step S703, the web browser 200 identifies the board type of the board displayed last time in step S704. For example, the web browser 200 may identify the board type displayed last time by the determination unit implemented by executing web content (for example, JavaScript etc.) acquired from the redirect server program 320.

In the cookie, the URL of the board displayed by the web browser 200 and the board type are recorded in association with each other. However, if the URL of the board is different depending on the board type, the URL and the board type need not be associated and recorded.

In step S705, the request unit 203 of the web browser 200 transmits a board display request to the relay device 30. The board display request includes the result (for example, “shared” or “personal”) identified in step S704 described above.

In step S706, when receiving the board display request, the screen providing unit 321 of the redirect server program 320 transmits a guidance screen to the shared terminal 20.

In step S707, when the display control unit 202 of the web browser 200 receives the guidance screen as in step S106 of FIG. 8, the display control unit 202 displays, for example, the guidance screen G200 illustrated in FIG. 10.

In step S708, the type determination unit 324 of the redirect server program 320 determines the board type from the identified result included in the board display request from the shared terminal 20. That is, the type determination unit 324 determines that the board type is “shared board” when the identified result is “shared” and determines the board type as “personal board” when the specified result is “personal”.

Hereinafter, the description continues on the assumption that the board type is determined to be “shared board” in step S708 described above.

When the board type is determined to be “shared board” in step S708 described above, the request unit 322 of the redirect server program 320 transmits a shared board creation request to the relay program 310 in step S709.

Although the example illustrated in FIG. 20 A and FIG. 20B illustrates a case where the shared terminal 20 identifies the board type from the cookie, the personal terminal 10 may similarly be able to identify the board type from the cookie. Also, the shared terminal 20 (or the personal terminal 10) may transmit a cookie to the relay device 30, and the relay device 30 may identify the board type (for example, “personal” or “shared”) of the board that the relay device 30 displayed last time from the cookie.

As described above, in the meeting service system 1 according to the present embodiment, the shared board or the personal board can be automatically redirected according to the information recorded in the cookies of the web browser 100 and the web browser 200. When the user of the shared terminal 20 is redirected to the personal board, the personal board used by the user of the shared terminal 20 is created in the same manner as the personal terminal 10. Thereby, the user of the personal terminal 10 and the shared terminal 20 can display, for example, a board of the same board type as the board type of the board displayed last time.

In addition, although the board type of the board displayed last time was identified in step S704 of FIG. 20A, other methods may be used. For example, after counting the number of board types of boards displayed during a predetermined period in the past, the board type with the larger number of counts may be identified from the board types “shared” and “personal”. Also, the use of a cookie is but an example, and alternatively the board type may be identified from information stored in a storage space such as an auxiliary storage device, for example.

Note that the determination in step S 708 of FIG. 20A may be performed by the web browser 200 (or the web browser 100).

### Third Embodiment

Hereinafter, a description is given of a third embodiment of the present disclosure. In the electronic meeting, for example, an electronic whiteboard is often used as the shared terminal 20, and a notebook PC or the like is often used as the personal terminal 10. Also, while relatively large devices such as electronic whiteboards often use a wired local area network (LAN), etc., as a communication method, portable devices such as a notebook PC and a smartphone often use a wireless communication method.

In the third embodiment, a case in which the board type of the board to be displayed at the request source is determined according to the communication method is described. Further, in the third embodiment, a case in which a web browser 330 is installed on the relay device 30 and the board is displayed by the web browser 330 is described.

In the description of the third embodiment, basically the differences from the first embodiment are described, and descriptions of the same components as the first embodiment are omitted or simplified as appropriate.

<Functional Configuration>

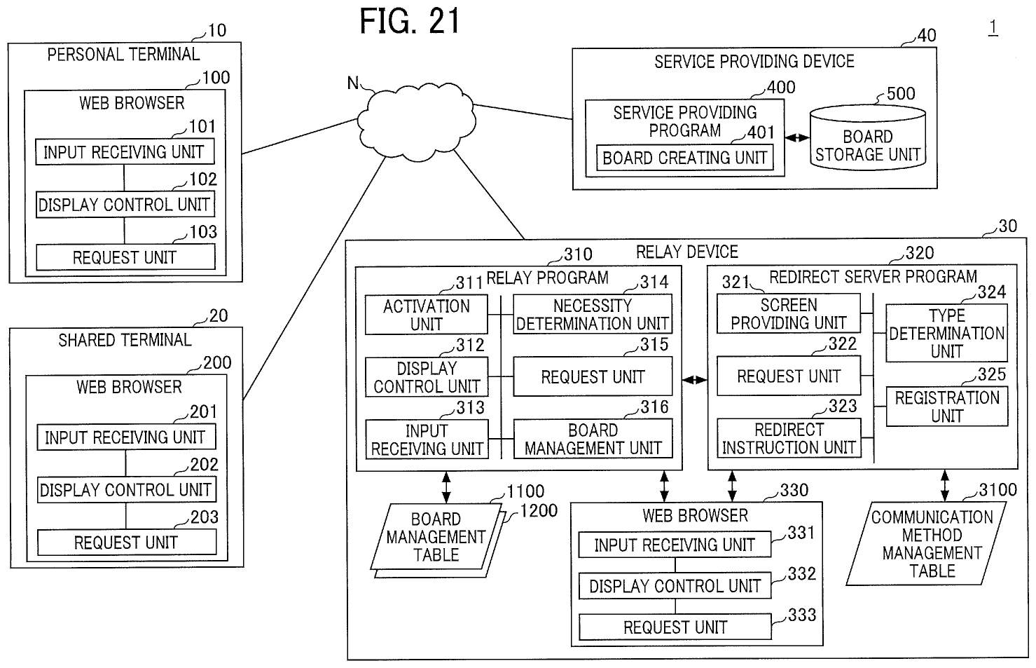

The functional configuration of the meeting service system 1 according to the present embodiment is described with reference to FIG. 21. FIG. 21 is a diagram illustrating an example of a functional configuration of the meeting service system, according to the third embodiment. The functional configurations of the personal terminal 10, the shared terminal 20, and the service providing device 40 are the same as in the first embodiment, and thus the description thereof is omitted.

Relay Device 30

As illustrated in FIG. 21, the relay device 30 according to the present embodiment includes an input receiving unit 331, a display control unit 332, and a request unit 333. These units are implemented by processing that the web browser 330 causes the CPU to execute. In particular, when the web browser 330 causes the CPU to execute processing related to web content, all or part of the processing performed by each of the units is implemented.

The input receiving unit 331 receives various inputs (for example, input of a URL, etc.) by the user. The display control unit 332 displays various screens (for example, a shared board screen etc.). The request unit 333 transmits various requests (for example, a shared board display request and the like).

In addition, the type determination unit 324 according to the present embodiment determines the board type of the board to be accessed by the request source of the board display request with reference to a communication method management table 3100.

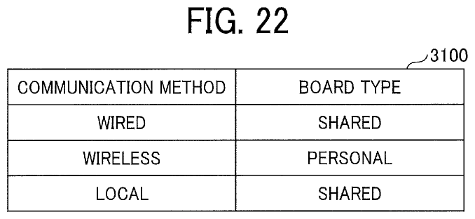

The communication method management table 3100 is a table for managing a board type for each communication method. The communication method management table 3100 is stored, for example, in an auxiliary storage device or the like. The communication method management table 3100 is described with reference to FIG. 22. FIG. 22 is a diagram illustrating an example of the communication method management table 3100.

As illustrated in FIG. 22, the communication method management table 3100 stores the communication method and the board type in association with each other. The communication method includes, for example, “wired”, “wireless”, “local” or the like. The communication method “wired” indicates that the communication is performed by wired connection, and the communication method “wireless” indicates that the communication is performed by wireless connection. Also, the communication method “local” indicates that the communication is within the relay device 30.

In the communication method management table 3100, the board type for each communication method is stored. The type determination unit 324 determines the board type according to the communication method of the request source of the board display request with reference to the communication method management table 3100. For example, when the communication method is “wired” or “local”, the type determination unit 324 determines that the board type is “shared board”. On the other hand, for example, when the communication method is “wireless”, the type determination unit 324 determines that the board type is “personal board”.

<Details of Processing>

Next, the details of processing of the meeting service system 1 according to the present embodiment are described. In the following, a meeting start process using the shared terminal 20 and a meeting start process using the relay device 30 is described. The processes other than those described below are the same as in the first embodiment.

Meeting Start Process Using Shared Terminal 20

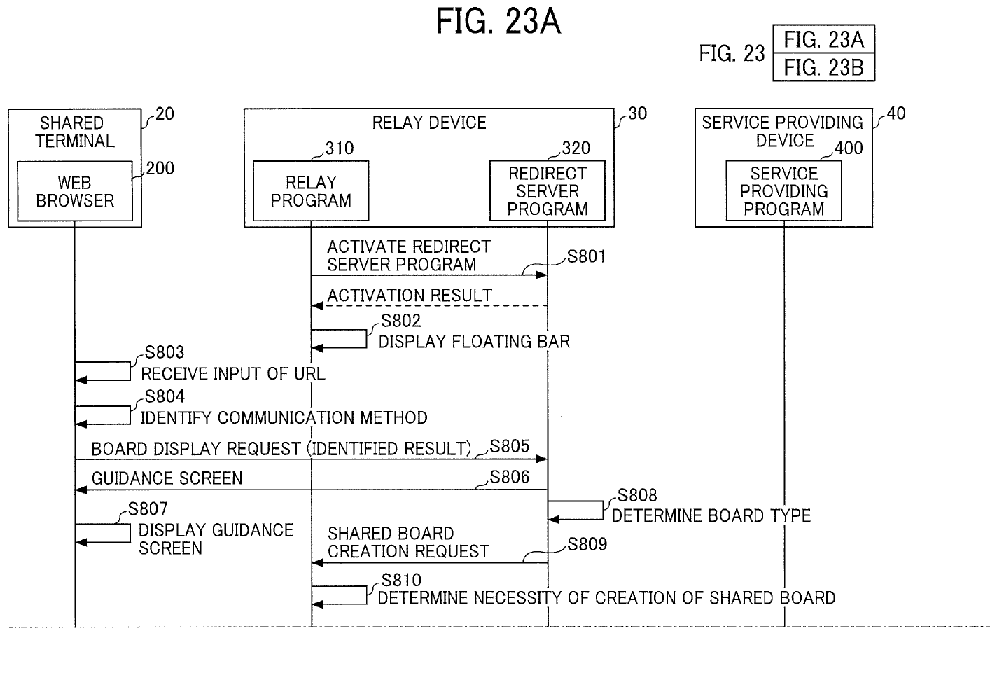

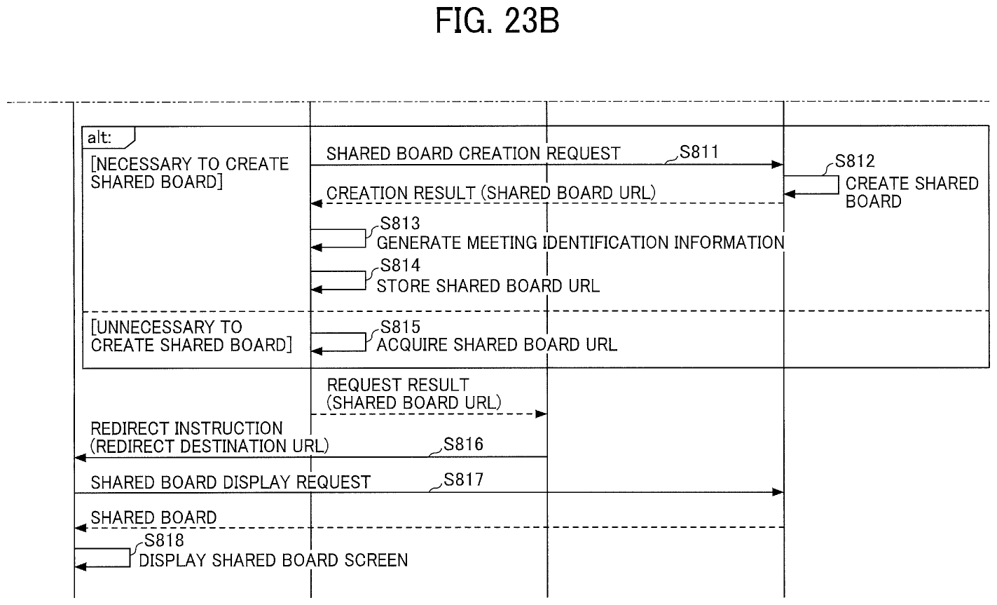

In the following, when starting the electronic meeting using the shared terminal 20, a process of determining the board type from the communication method of the shared terminal 20 is described with reference to FIG. 23A and FIG. 23B. FIG. 23A and FIG. 23B are sequence diagrams illustrating an example of a process of starting a meeting using the shared terminal 20 according to the third embodiment. Note that steps S801 to S803 and steps S810 to S818 in FIG. 23 A and FIG. 23B are the same as steps S101 to S103 and steps S109 to S117 in FIG. 8. and thus, the description thereof is omitted.

Following step S803, the web browser 200 identifies a communication method in step S804. For example, the web browser 200 may identify the communication method by the determination unit implemented by executing the web content (for example, JavaScript or the like) acquired from the redirect server program 320. The communication method may be identified, for example, by querying the device manager of the OS.

In step S805, the request unit 203 of the web browser 200 transmits a board display request to the relay device 30. The board display request includes the communication method (for example, “wired” or “wireless” or the like) identified in step S804 described above. However, for example, when the redirect server program 320 that has received the request from the web browser 200 can determine the communication method of the shared terminal 20 on which the web browser 200 is installed, the web browser 200 does not need to identify the communication method. Alternatively, the web browser 200 does not have to include the identified communication method in the board display request.

In step S806, when receiving the board display request, the screen providing unit 321 of the redirect server program 320 transmits a guidance screen to the shared terminal 20.

In step S807, when the display control unit 202 of the web browser 200 receives the guidance screen, as in step S106 of FIG. 8, the display control unit 202 displays, for example, the guidance screen G200 illustrated in FIG. 10.

In step S808, the type determination unit 324 of the redirect server program 320 determines the board type from the identification result included in the board display request from the shared terminal 20 with reference to the communication method management table 3100. The type determination unit 324 determines that the board type is “shared board” when the identification result is “wired” or “local”, and “personal board” when the identification result is “wireless”.

Hereinafter, the description continues on the assumption that the board type is determined to be “shared board” in step S808 described above.

When the board type is determined to be “shared board” in step S808, the request unit 322 of the redirect server program 320 transmits a shared board creation request to the relay program 310 in step S809.

Although the example illustrated in FIG. 23A and FIG. 23B illustrates a case in which the shared terminal 20 identifies the communication method, alternatively the personal terminal 10 may similarly be able to identify the communication method.

As described above, in the meeting service system 1 according to the present embodiment, the shared board or the personal board can be automatically redirected according to the communication method identified by the web browser 100 and the web browser 200. When the user of the shared terminal 20 is redirected to the personal board, the personal board used by the user of the shared terminal 20 is created in the same manner as the personal terminal 10. Thereby, the user of the personal terminal 10 and the shared terminal 20 can display, for example, a board of a board type according to the communication method.

The determination in step S808 in FIG. 23A may be performed by the web browser 200 (or the web browser 100).

Meeting Start Process Using Relay Device 30

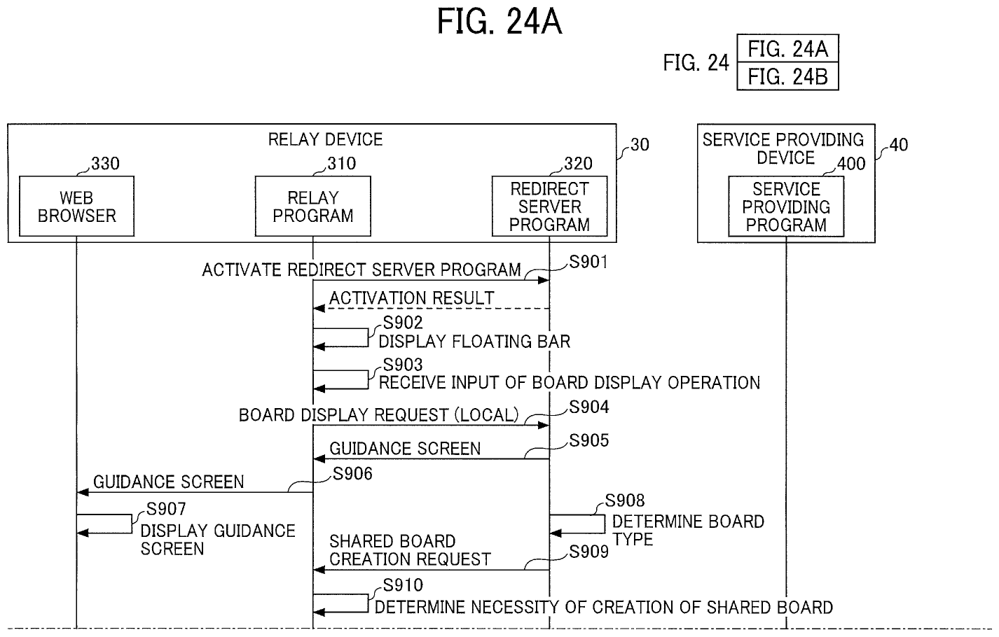

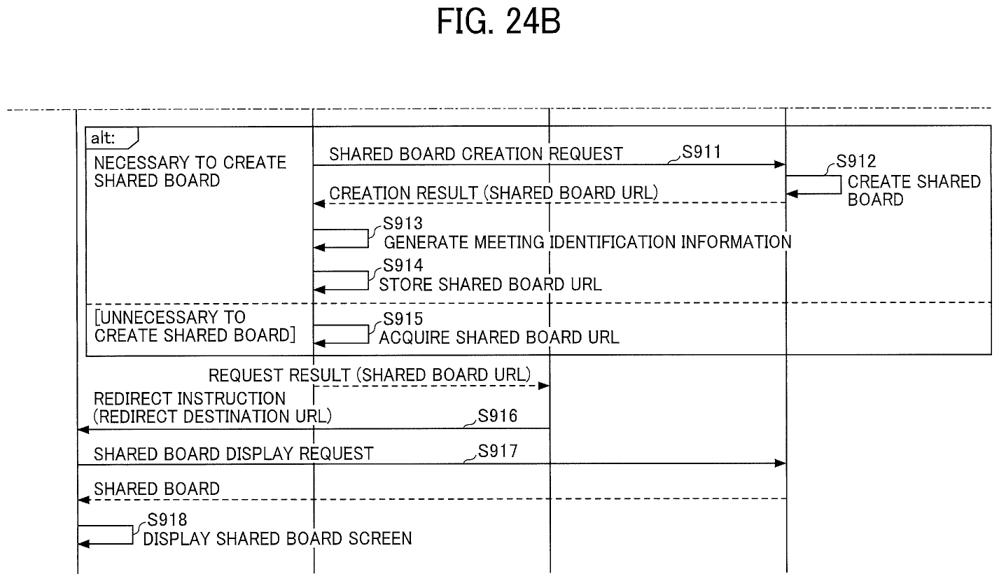

A process of determining the board type from the communication method of the relay device 30 when starting the electronic meeting using the relay device 30 is described with reference to FIG. 24 A and FIG. 24B. FIG. 24A and FIG. 24B are sequence diagrams illustrating an example of a process of starting a meeting using the relay device 30 according to the third embodiment. Steps S901 to S902 and steps S909 to S915 in FIG. 24A and FIG. 24B are the same as steps S101 to S102 and steps S108 to S114 in FIG. 8, and thus the description thereof is omitted.

Subsequent to step S902, the input receiving unit 313 of the relay program 310 receives an input of a board display operation in step S903. The user of the relay device 30 can perform the board display operation, for example, by pressing the shortened URL of the floating bar displayed in step S902.

In step S904, the request unit 315 of the relay program 310 transmits a board display request to the redirect server program 320. The board display request includes the communication method “local”. As described above, when the user of the relay device 30 performs the board display operation in step S903 described above, the board display request includes the communication method “local”.

When receiving the board display request, the screen providing unit 321 of the redirect server program 320 transmits a guidance screen to the relay program 310 in step S905.

In step S906, the request unit 315 of the relay program 310 transmits the guidance screen from the redirect server program 320 to the web browser 330. When the web browser 330 is not activated at this time, the request unit 315 transmits the guidance screen after activating the web browser 330.

When the display control unit 332 of the web browser 330 receives the guidance screen as in step S106 of FIG. 8, the display control unit 332 displays, for example, the guidance screen G200 illustrated in FIG. 10 in step S907.

In step S908, the type determination unit 324 of the redirect server program 320 refers to the communication method management table 3100 to set the board type as “shared board” from the communication method “local” included in the board display request from the shared terminal 20.

In step S916 the redirect instruction unit 323 of the redirect server program 320 transmits a redirect instruction with the shared board URL as the redirect destination URL to the web browser 330.

In step S917, the request unit 333 of the web browser 330 transmits a shared board display request to the redirect destination URL. Thereby, the shared board (more precisely, web content for displaying the shared board) is returned from the service providing device 40.

When receiving the shared board, the display control unit 332 of the web browser 330 displays, for example, the shared board screen G300 illustrated in FIG. 11 in step S918. Thus, the user of the relay device 30 can conduct the electronic meeting using the shared board.

As described above, in the meeting service system 1 according to the present embodiment, when the electronic meeting is started using the web browser 330 of the relay device 30, the shared board can be automatically redirected.

Although FIG. 24A and FIG. 24B describe the case in which the shortened URL of the floating bar is pressed in step S903 described above, the user may input the shortened URL into the address bar or the like of the web browser 330. In this case, the web browser 330 may perform the same processing as steps S803 to S805 in FIG. 23A. The web browser 330 identifies the communication method as “local” in step S804.

### Fourth Embodiment

Hereinafter, a description is given of a fourth embodiment of the present disclosure. In the fourth embodiment, a case in which after the shared terminal 20 causes the service providing device 40 to create both the shared board and the personal board, one of the boards is displayed on the web browser 200 according to the board type is described. The user can switch and display the shared board screen and the personal board screen, for example, by switching a tab or the like of the web browser 200.

The following description of the fourth embodiment basically describes the differences from the first embodiment, and descriptions of the same components as the first embodiment are omitted or simplified as appropriate. In the fourth embodiment, a meeting start process using the shared terminal 20 is described. The processes other than the meeting start process using the shared terminal 20 are the same as in the first embodiment.

<Details of Processing>

Details of the processing of the meeting service system 1 according to the present embodiment are described.

Meeting Start Process Using Shared Terminal 20

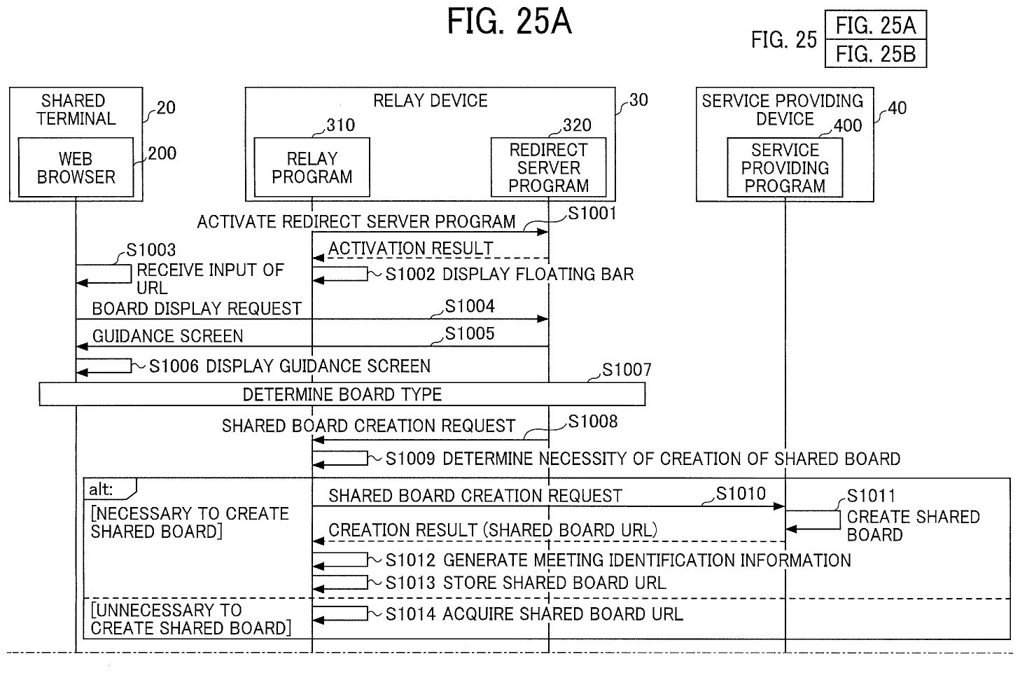

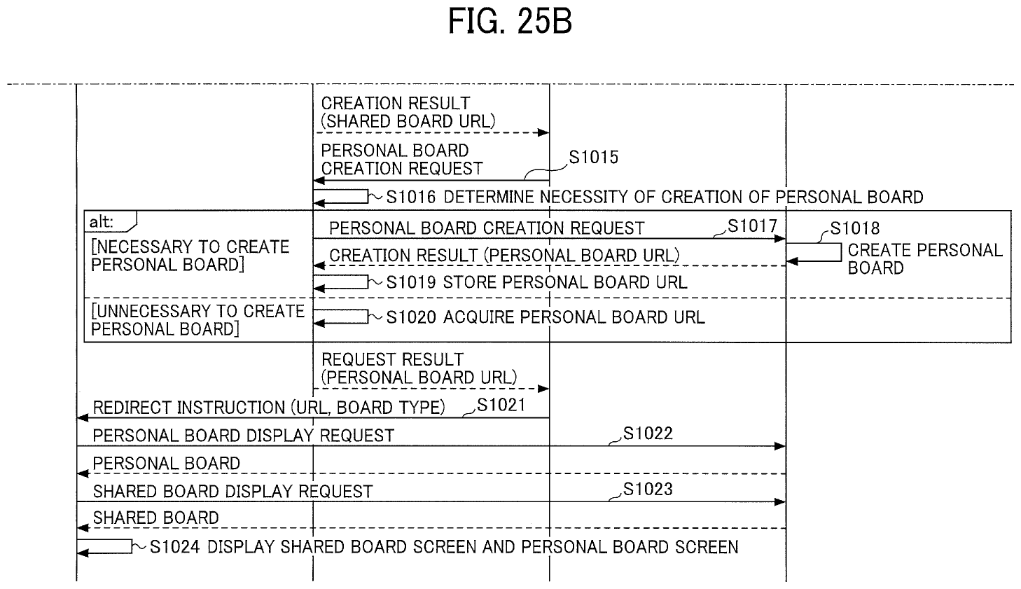

Hereinafter, a process of switching between displaying one of the shared board and the personal board when using the shared terminal 20 to start the electronic meeting is described with reference to FIG. 25A and FIG. 25B. FIG. 25A and FIG. 25B are sequence diagrams illustrating an example of a process of starting a meeting using the shared terminal 20 according to the fourth embodiment. Steps S1001 to S1003 in FIG. 25A are the same as steps S101 to S103 in FIG. 8, and thus the description thereof is omitted.

Subsequent to step S1002, the request unit 203 of the web browser 200 transmits a board display request to the relay device 30 in step S1004.

When receiving the board display request, the screen providing unit 321 of the redirect server program 320 transmits a guidance screen to the shared terminal 20 in step S1005.

When the display control unit 202 of the web browser 200 receives the guidance screen as in step S106 of FIG. 8, the display control unit 202 displays, for example, the guidance screen G200 illustrated in FIG. 10 in step S1006.

In step S1007, the meeting service system 1 according to the present embodiment determines the board type. As the method of determining the board type, any one of the methods described in the first to third embodiments may be used. Hereinafter, the description continues on the assumption that the board type is determined as “shared board” in step S1007 described above.

The subsequent steps S1009 to S1014 are the same as steps S109 to S114 in FIG. 8, and thus the description thereof is omitted. Further, steps S1015 to S1020 are the same as steps S206 to S211 in FIG. 12, and thus the description thereof is omitted. Thereby, the shared board and the personal board are created, and the shared board URL and the personal board URL are sent back from the service providing device 40 to the relay device 30.

Subsequent to step S1019 or step S1020, the redirect instruction unit 323 of the redirect server program 320 transmits a redirect instruction to the shared terminal 20 (the request source of the board display request in step S1004) in step S1021. Here, the redirect instruction includes the shared board URL and the personal board URL as the redirect destination URL. Also, the redirection instruction includes the board type (that is, “shared board”) determined in step S1007 described above.

In step S1022, the request unit 203 of the web browser 200 transmits a personal board display request to the personal board URL. In response, the personal board is returned from the service providing device 40.

In step S1023, the request unit 203 of the web browser 200 transmits a shared board display request to the shared board URL. In response, the shared board is sent back from the service providing device 40.

In step S1024 the display control unit 202 of the web browser 200 displays the personal board screen and the shared board screen. The display control unit 202 displays, for example, the personal board screen and the shared board screen on different tabs and displays the tab on which the shared board screen is displayed in the foreground. As a result, the shared board screen is displayed. The user can also display the personal board screen by switching the tab of the web browser 200.

Note that, when the board type “personal board” is included in the redirect instruction in step S1021, the display control unit 202 displays, for example, the personal board screen and the shared board screen in different tabs, and the personal board screen is displayed in the foreground. When the web browser 200 is not a tab browser or the like, a window in which the personal board screen or the shared board screen is displayed may be displayed in the foreground.

As described above, the display control unit 202 controls to preferentially display boards of the board type included in the redirect instruction.

Although the example illustrated in FIG. 25A and FIG. 25B illustrates a case in which either the shared board screen or the personal board screen is displayed on the front of the shared terminal 20, the personal terminal 10 similarly displays the shared board screen or the personal board screen and one of the boards may be displayed in the foreground.

As described above, in the meeting service system 1 according to the present embodiment, one of the shared board screen or the personal board screen is preferentially displayed on the shared terminal 20 (or the personal terminal 10) in a switchable manner. As a result, the shared terminal 20 (or the personal terminal 10) can switch to the other board while preferentially using the board frequently used by itself.

In the example illustrated in FIG. 25A and FIG. 25B, the case in which the board type is included in the redirect instruction in step S1021 described above has been described. However, the board type need not be included in the redirect instruction. In this case, the redirect instruction unit 323 may transmit the redirect instruction to the shared terminal 20 twice in accordance with the board type determined in step S1007 described above.

Specifically, when the board type determined in step S1007 above is “shared board”, the redirect instruction unit 323 may transmit the redirect instruction including the shared board URL to the shared terminal 20 after transmitting the redirect instruction including the personal board URL to the shared terminal 20. As a result, after the personal board screen is displayed by the display control unit 202 of the web browser 200, the shared board screen is displayed, and thus the shared board screen is displayed in the foreground.

On the other hand, when the board type determined in step S1007 above is “personal board”, the redirect instruction unit 323 may transmit the redirect instruction including the personal board URL to the shared terminal 20 after transmitting the redirect instruction including the shared board URL to the shared terminal 20. As a result, after the shared board screen is displayed by the display control unit 202 of the web browser 200, the personal board screen is displayed, and thus the personal board screen is displayed in the foreground.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

1. An information processing system for providing an electronic meeting service between terminals, the information processing system comprising:
an information processing apparatus; and
a plurality of terminals connected to the information processing apparatus;
the information processing apparatus comprising:
circuitry configured to:
determine, in response to a request sent from one of the terminals to a first address to start an electronic meeting, which one of personal content for each terminal and shared content shared between the terminals to display on the terminal that accessed the first address; and
redirect the terminal that accessed the first address to one of a second address of the personal content and a third address of the shared content, according to a determination result.

2. The information processing system of claim 1, wherein
when a type of the terminal that has accessed the first address is a personal terminal indicating that the terminal is used by one user, the circuitry determines that the personal content is to be displayed, and
when the type of the terminal that has accessed the first address is a shared terminal indicating that the terminal is used by multiple users simultaneously, the circuitry determines that the shared content is to be displayed.

3. The information processing system of claim 1, wherein the circuitry is further configured to:
determine whether the personal content has been created, when it is determined that the personal content is to be displayed;
determine whether the shared content has been created when it is determined that the shared content is to be displayed;
create the personal content of the terminal that accessed the first address when it is determined that the personal content has not been created; and
create the shared content when it is determined that the shared content has not been created.

4. The information processing system of claim 1, wherein the circuitry is further configured to:
when identification information of the terminal that has accessed the first address is not stored in a table in which identification information of a terminal for displaying the shared content is stored, determine that the personal content is to be displayed; and
when the identification information of the terminal that has accessed the first address is stored in the table in which the identification information of the terminal for displaying the shared content is stored, determine that the shared content is to be displayed.

5. The information processing system of claim 1, wherein the circuitry is further configured to determine which one of the personal content and the shared content is to be displayed on the terminal that has accessed the first address, based on a selection received by the terminal.

6. The information processing system of claim 1, wherein the circuitry is further configured to determine which one of the personal content and the shared content is to be displayed, based on information managed by browser installed in the terminal that has accessed the first address.

7. The information processing system of claim 1, wherein the circuitry is further configured to determine which one of the personal content and the shared content is to be displayed, based on a communication method of the terminal that has accessed the first address.

8. An information processing apparatus for providing an electronic meeting service between a plurality of terminals, the information processing apparatus comprising:
circuitry configured to:
determine, in response to a request sent from one of the terminals to a first address to start an electronic meeting, which one of personal content for each terminal and shared content shared between the terminals to display on the terminal; and
redirect the terminal that accessed the first address to one of a second address of the personal content and a third address of the shared content, according to a determination result.

9. An information processing method comprising:
determining, in response to a request sent from one of a plurality of terminals to a first address to start an electronic meeting, which one of personal content for each terminal and shared content shared between the terminals to display on the terminal that accessed the first address; and
redirecting the terminal that accessed the first address to one of a second address of the personal content and a third address of the shared content, according to a determination result.

10. A machine-readable non-transitory recording medium storing a plurality of instructions which, when executed by one or more processors, cause the processors to perform the information processing method of claim 9.
